(19) United States
(12) Patent Application Publication
(10) Pub. No.: US 2025/0294499 A1
(43) Pub. Date: Sep. 18, 2025

(54) METHODS AND SYSTEMS FOR PRIORITIZING CELLS FOR POSITIONING MEASUREMENT

(71) Applicant: QUALCOMM Incorporated, San Diego, CA (US)

(72) Inventors: Bapineedu Chowdary Gummadi, Hyderabad (IN); Stephen William Edge, Escondido, CA (US)

(21) Appl. No.: 18/606,104

(22) Filed: Mar. 15, 2024

(51) Int. Cl. H04W 64/00; G01S 5/00; H04L 5/00

(52) U.S. Cl. CPC H04W 64/00; G01S 5/0027; G01S 5/0036; H04L 5/0051; G01S 2205/008

(57) ABSTRACT

This disclosure provides systems, methods, and devices for wireless communication that enhance positioning determination operations with cell prioritization. In a first aspect, a method of wireless communication includes receiving cell list information for positioning reference signals measurement and cell priority information associated with the cell list information. The method also includes monitoring for a positioning reference signal from a particular cell, the particular cell determined based on the cell priority information. The method further includes determining positioning information based on the positioning reference signal. Other aspects and features are also claimed and described.

### TECHNICAL FIELD

Aspects of the present disclosure relate generally to wireless communication systems, and more particularly, to positioning determination operations. Certain embodiments of the technology discussed below may enable and provide cell priority based positioning determination operation enhancements for wireless communication systems.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Interference and other RF signaling problems, such as low signal strength, signal attenuation and signal propagation over long distances, may impair location and location services for UEs and may require new techniques for mitigation.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes receiving cell list information for positioning reference signals measurement and cell priority information associated with the cell list information. The method also includes monitoring for a positioning reference signal from a particular cell, the particular cell determined based on the cell priority information. The method further includes determining positioning information based on the positioning reference signal.

In an additional aspect of the disclosure, an apparatus includes at least one processor and a memory coupled to the at least one processor. The at least one processor is configured to cause the apparatus to: receive cell list information for positioning reference signals measurement and cell priority information associated with the cell list information; monitor for a positioning reference signal from a particular cell, the particular cell determined based on the cell priority information; and determine positioning information based on the positioning reference signal.

In another aspect of the disclosure, a method for wireless communication includes receiving user equipment (UE) information and cell type information. The method also includes generating cell priority information based on the UE information and the cell type information. The method further includes sending cell list information for positioning determination and the cell priority information.

In an additional aspect of the disclosure, an apparatus includes at least one processor and a memory coupled to the at least one processor. The at least one processor is configured to cause the apparatus to: receive user equipment (UE) information and cell type information; generate cell priority information based on the UE information and the cell type information; and send cell list information for positioning determination and the cell priority information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the numeric reference label by a letter or by a dash and/or a second numeric label that distinguishes among the similar components. If just the first numeric reference label is used in the specification, the description is applicable to any one of the similar components having the same first numeric reference label irrespective of the second label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a ladder diagram illustrating an example wireless communication system that supports positioning determination according to one or more aspects.

FIG. 4 is a block diagram illustrating an example wireless communication system that supports enhanced positioning determination with cell priority information according to one or more aspects.

FIG. 5 is a ladder diagram illustrating another example wireless communication system that supports enhanced positioning determination with cell priority information according to one or more aspects.

FIG. 6 is a ladder diagram illustrating another example wireless communication system that supports enhanced positioning determination with cell priority information according to one or more aspects.

FIG. 7 is a ladder diagram illustrating another example wireless communication system that supports enhanced positioning determination with cell priority information according to one or more aspects.

FIG. 8 is a ladder diagram illustrating another example wireless communication system that supports enhanced positioning determination with cell priority information according to one or more aspects.

FIG. 9 is a flow diagram illustrating an example process that supports enhanced positioning determination operations with cell prioritization according to one or more aspects.

FIG. 10 is a flow diagram illustrating another example process that supports enhanced positioning determination operations with cell prioritization according to one or more aspects.

FIG. 11 is a block diagram of an example UE that supports enhanced positioning determination operations with cell prioritization according to one or more aspects.

FIG. 12 is a block diagram of an example network device that supports enhanced positioning determination operations with cell prioritization according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail device or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

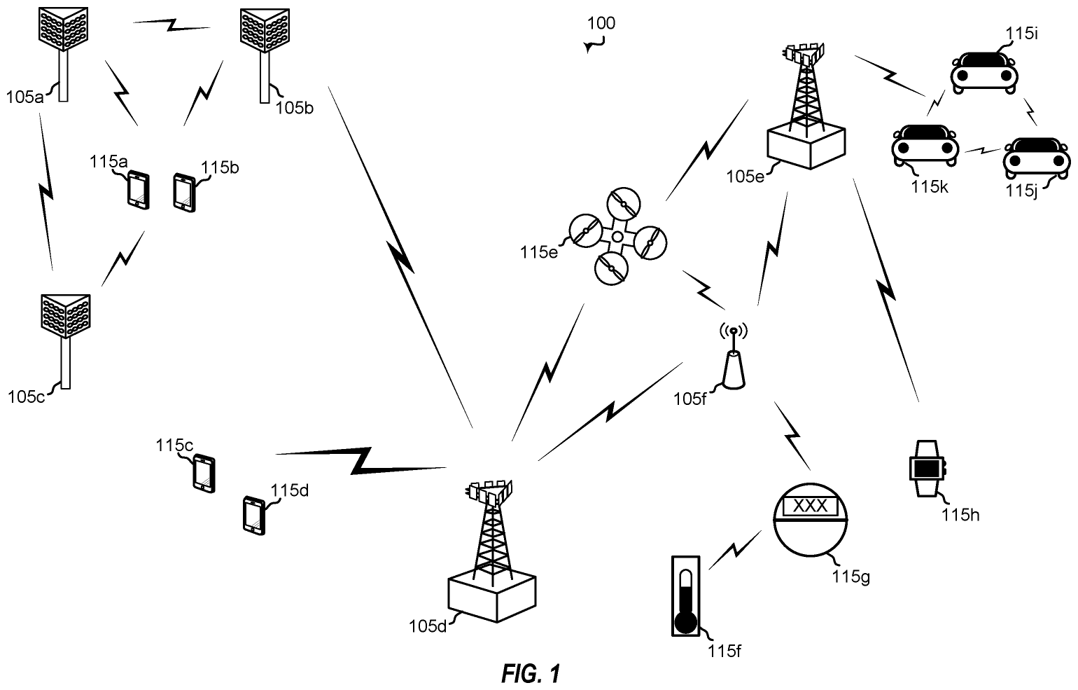

FIG. 1 is a block diagram illustrating details of an example wireless communication system according to one or more aspect. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

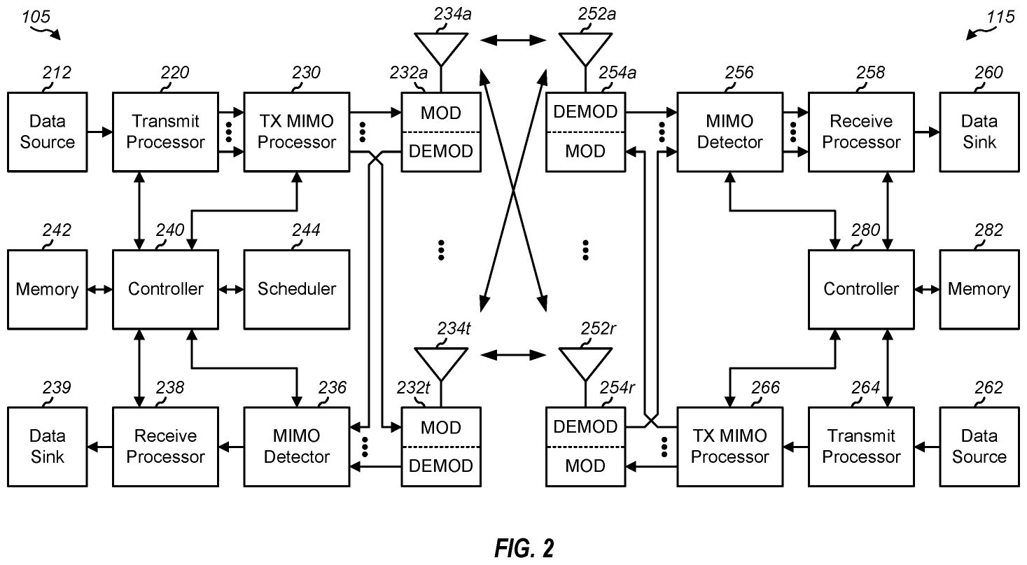

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

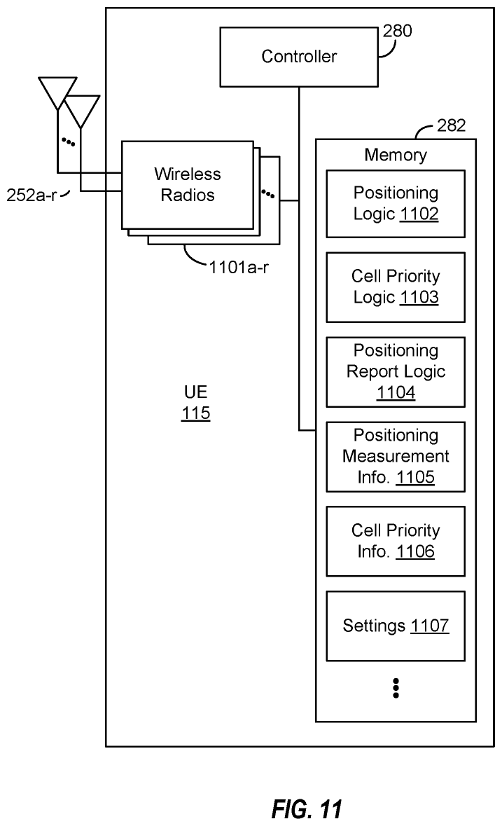

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 10 and 11, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

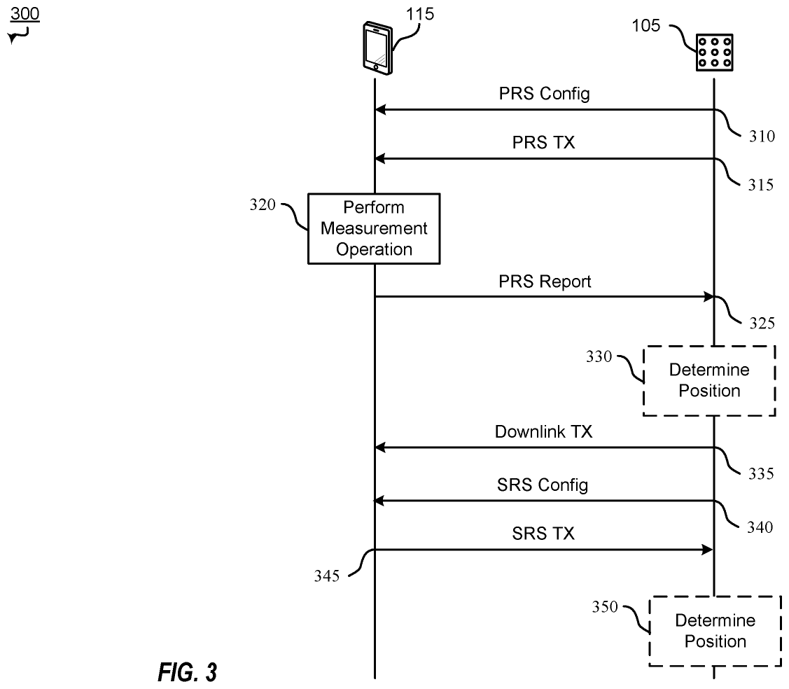

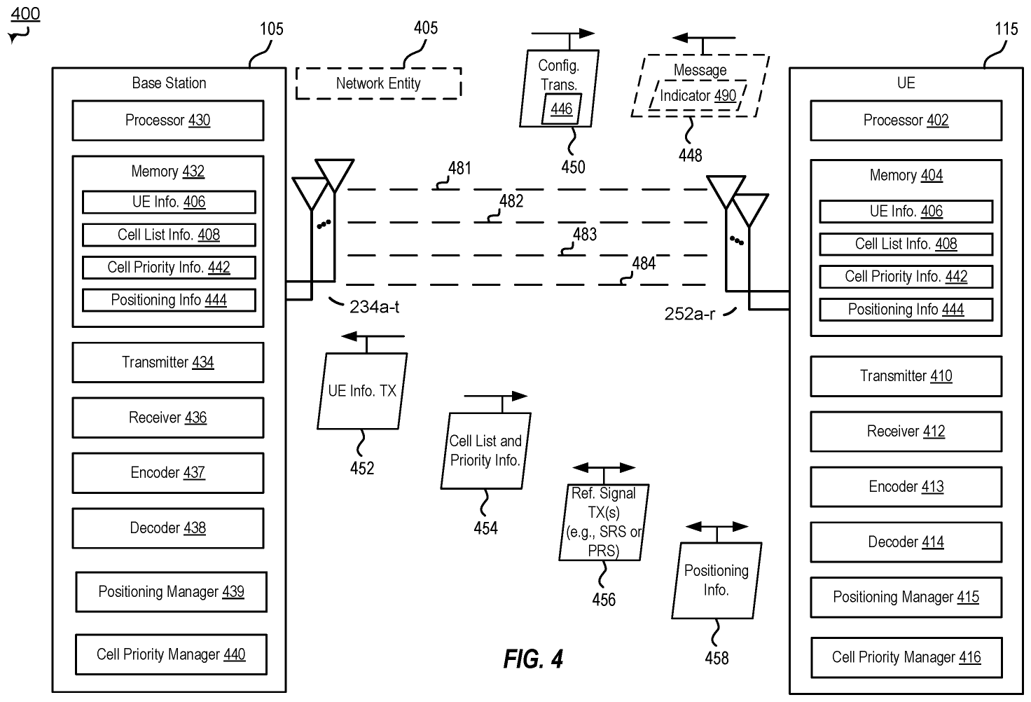

FIG. 3 illustrates an example system and corresponding positioning operations for uplink positioning determination and downlink positioning determination according to some aspects. The example of FIG. 3 includes similar devices to the devices described in FIGS. 1 and 2, such as UE 115 and base station 105. The devices, such as UE 115 and base station 105, of FIG. 3 may include one or more of the components as described in FIGS. 2 and 4.

Referring to FIG. 3, FIG. 3 is a ladder diagram 300 of collocated positioning operations according to some aspects. In the example of FIG. 3, the ladder diagram illustrates a UE 115 and a network entity, such as base station 105 collocated or associated with a location management function (LMF).

At 310, the base station 105 (such as a gNB) transmits Positioning Reference Signal (PRS) configuration information to the UE 115. For example, the positioning manager 439 of the base station 105 described later for FIG. 4 generates and transmits a configuration message to the UE 115 which includes the PRS configuration information. The PRS configuration information may include information for the PRS transmission itself, for a corresponding report, or both. The information may include settings, formats, transmission resources, etc. (e.g., including PRS transmission frequency, bandwidth, coding, transmission times). The PRS configuration message may include or correspond to a higher layer message, such as a layer 3 message. For example, the base station 105 generates a Radio Resource Control (RRC) message which indicates or includes the PRS configuration information or the associated or collocated LMF generates an LPP message which indicates or includes the PRS configuration information. In some implementations, the PRS configuration message is sent to multiple UEs (e.g., is sent to the multiple UEs by the base station 105 using broadcast). In other implementations, the PRS configuration message is a PDCCH transmission, such as a DCI, or a MAC CE. Additionally, or alternatively, the PRS configuration message may schedule multiple PRS transmissions and/or reports (e.g., periodic or semi-static) or schedule/trigger a single PRS transmission and report (e.g., aperiodic).

At 315, the base station 105 transmits a PRS to the UE 115 (e.g., where the transmitted PRS has the configuration indicated at 310). For example, the positioning manager 439 of the base station 105 generates and transmits a PRS transmission to the UE 115 for measurement operations. In some implementations, the PRS is sent to multiple devices, such as multiple UEs. In other implementations, the PRS is sent to a single device. Alternatively, another position RS may be used for position measurement operations.

At 320, the UE 115 performs a measurement operation on the PRS. For example, the positioning manager 415 of the UE 115 processes and measures the PRS transmission to generate measurements, such as measurement information. The measurement information may include or correspond to data associated with or corresponding to measurements of the PRS transmission which enable the generation of position/location information. The measurement information may include signal strength or quality measurements, such as reference signal receive power (RSRP), reference signal receive quality (RSRQ), received signal strength indicator (RSSI), etc. Additionally, or alternatively, the measurement information may include directionality information, such as angle or arrival (AoA) or beam related information (beamforming weights or pre-set beams). In addition or instead, the measurement information may include timing information, such a receive-transmit time difference (Rx-Tx), a time of arrival (TOA) or a reference signal time difference (RSTD).

The UE 115 may measure or evaluate the PRS transmission using a single signal path or multiple signal paths. Measuring or evaluating the PRS transmission for multiple signal paths may include determining multiple measurements for a single PRS transmission.

At 325, the UE 115 transmits a PRS report based on the PRS measurement operation. For example, the positioning manager 415 of the UE 115 generates and transmits a PRS report message to the base station 105, such as an associated or collocated LMF thereof. The PRS report of the PRS report message may be generated and transmitted based on the PRS configuration information and/or the measurement information. For example, the timing and structure of the PRS report may be determined based on the PRS configuration information and/or the content of the PRS report may be determined based on the measurement information. The PRS report message may include or correspond to a higher layer message, such as a layer 3 message. For example, the UE 115 generates an LTE Positioning Protocol (LPP) message which includes the PRS measurement report. In other implementations, the PRS report is a PUCCH transmission, such as an uplink control information (UCI), a PUSCH transmission, or a MAC CE. Alternatively, for sidelink operations where the UE 115 receives a PRS from another UE, the PRS report may be a SCI or a MAC CE.

In some implementations, the UE 115 may additionally send the PRS report to one or more other devices, such as another UE, an anchor device, or another base station. Transmission of the PRS report to other devices is described further with reference to FIG. 4-8.

At 330, the base station 105 or the associated or collocated LMF may optionally determine position information based on the PRS report. For example, the positioning manager 439 of the base station 105 (e.g., a LMF thereof) may determine a position of the UE 115 based on the PRS report, including the antenna configuration indicated thereby, or positioning assistance information, such as information which indirectly indicate the position (e.g., TOA/RTT).

At 335, the base station 105 may transmit a downlink transmission based on the PRS report. For example, the base station 105 (e.g., a LMF thereof) may use the determined position (e.g., updated or more accurate position) of the UE 115 to transmit a PDCCH or PDSCH transmission (e.g., the positioning information transmission 458 of FIG. 4).

At 340, the base station 105 (such as a gNB) may transmit a Sounding Reference Signal (SRS) configuration information to the UE 115. For example, the positioning manager 439 of the base station 105 generates and transmits an SRS configuration message to the UE 115 which includes the SRS configuration information. The SRS configuration information may include information for an uplink (UL) SRS transmission. The information may include settings, formats, transmission resources, etc. The SRS configuration message may include or correspond to a higher layer message, such as a layer 3 message. For example, the base station 105 generates a RRC message which indicates or includes the SRS configuration information. In some implementations, the SRS configuration message is sent to multiple UEs. In other implementations, the SRS configuration message is a PDCCH transmission, such as a DCI, or a MAC CE. Additionally, or alternatively, the SRS configuration message may schedule multiple SRS transmissions and/or reports (e.g., periodic or semi-static) or schedule/trigger a single SRS transmission and report (e.g., aperiodic).

At 345, the UE 115 transmits an UL SRS to the base station 105. For example, the positioning manager 415 of the UE 115 generates and transmits an UL SRS transmission to the base station 105 for measurement operations. In some implementations, the SRS is sent to multiple devices, such as multiple network devices. In other implementations, the SRS is sent to a single device. Alternatively, another reference signal may be used for position measurement operations.

At 350, the base station 105 performs a measurement operation on the UL SRS. For example, the positioning manager 439 of the base station 105 processes and measures the SRS transmission to generate measurements, such as UL measurement information. The UL measurement information may include or correspond to data associated with or corresponding to measurements of the UL SRS transmission which enable the generation of position/location information. The UL measurement information may include signal strength or quality measurements, such as RSRP, RSRQ, RSSI, etc. Additionally, or alternatively, the UL measurement information may include directionality information, such as angle or arrival (AoA) or beam related information (beamforming weights or pre-set beams). In addition or instead, the UL measurement information may include timing information, such a receive-transmit time difference (Rx-Tx), a time of arrival (TOA) or a time difference of arrival (TDOA).

The base station 105 may measure or evaluate the UL SRS transmission using a single signal path or multiple signal paths. Measuring or evaluating the UL SRS transmission for multiple signal paths may include determining multiple measurements for a single UL SRS transmission.

The base station 105 may then determine a position of or for the UE 115 and transmit a transmission to the UE 115 similar to as described with reference to 330 and 335. In some implementations, the transmission to the UE 115 may include or indicate the determined position, such that the UE 115 may utilize the determined position. The transmission to the UE 115 may be transmitted in or as a downlink control information (DCI), an uplink control information (UCI), a sidelink control information (SCI), Medium Access Control Control Element (MAC CE), or LTE Positioning Protocol (LPP) transmission. Thus, in the example in FIG. 3, the devices perform positioning determination operations for a network with a collocated architecture. In some aspects, 310 to 335 may occur but not 340 to 350, or 340 to 350 may occur but not 310 to 335.

In advanced wireless networks, UEs may have very different capabilities and may be operating under different operating conditions. For example, some UEs may have very advanced capabilities and minimal or no power constraints, while some other UEs may have strict power constraints, limited antennas, and/or reduced processing capabilities. Additionally, network devices may also have different capabilities and may be operating under different operating conditions. For example, some network devices, such as base stations, have complex antenna structures and advanced processing capabilities to serve fast moving devices.

In conventional networks, positioning determination (both uplink and downlink) does not leverage high performing cells for positioning determination operations. Additionally, the positioning determination does not account for UE type. Accordingly, positioning determination operations can be improved by leveraging UE type information and cell/base station information to improve positioning determinations for UEs.

Additionally, or alternatively, conventional positioning determination does not leverage UE state of motion for positioning determination operations. Accordingly, positioning determination operations can be improved by leveraging UE state of motion and cell/base station information to improve positioning determinations for UEs.

FIG. 4 illustrates an example of a wireless communications system 400 that supports enhanced positioning determination operations in accordance with aspects of the present disclosure. In some examples, wireless communications system 400 may implement aspects of wireless communication system 100. For example, wireless communications system 400 may include multiple wireless communication devices and optionally a network entity. In the example of FIG. 4, the wireless communications system 400 includes a base station 105, a UE 115, and a network entity 405 (e.g., a location server, such as an LMF). Enhanced positioning determination operations may utilize cell priority information to increase positioning accuracy, reduce positioning errors, and increase throughput. Thus, network and device performance can be increased.

Wireless communication devices, such as base station 105 and UE 115, may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHZ” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. UE 115 and base station 105 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via UE 115 and base station 105. For example, the control information may be communicated using MAC CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, positioning manager 415, cell priority manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store data, such as UE information 406, cell list information 408, cell priority information 442, positioning information 444, settings data 446, or a combination thereof, as further described herein.

The UE information 406 includes or corresponds to data associated with or corresponding to information regarding a UE type, UE motion, or a combination thereof. For example, the UE information 406 may include UE type information corresponding to a type, a status, and/or capability of the UE. For example, the UE type information may indicate a category of a UE, such as an unmanned aerial vehicle (UAV) UE, a vehicle UE, an IoT UE, or a handheld UE. The UE information 406 may also include UE motion information corresponding to an active or previous state of motion of the UE. For example, the UE motion information indicates the current state of motion of the UE, such as walking, running, cycling, on a vehicle, on a train, or flying. As other examples, the UE motion information may indicate a speed, a direction, a velocity, etc. The indication may be qualitative, high, medium, low, fast, slow, etc., or may be quantitative, two meters per second, 55 miles an hour, etc.

The cell list information 408 includes or corresponds to data indicating or corresponding to a list of cells and/or network devices (e.g., base stations) associated therewith. For example, the cell list information 408 may include data indicating a plurality of cells and a plurality of network devices (e.g., base stations) associated with the plurality of cells. In conventional operations, the cell list information 408 does not include information on the type of network device or devices that is or are associated with the cell, such as base station type. In the aspects described herein, cell priority information 442 can be used to convey additional information regarding the cells of the cell list.

The cell priority information 442 includes or corresponds to data associated with or corresponding to information regarding a cell and a priority associated with the cell, such as a type of network device or base station thereof, for positioning determination operations. For example, the cell priority information 442 may indicate or include cell type information, cell group information, or both, and may be determined based on cell type or cell group information received from cells (e.g., network devices thereof). To illustrate, the cell type information may indicate a category of a cell or base station thereof or associated with the cell, such as a macro cell, a pico cell, a femto cell, a high speed train (HST) cell, a non-terrestrial network (NTN) cell, a high antenna cell, a wall-mounted cell, a roof-mounted cell, a UAV-mounted cell, or an in-building cell.

The cell priority information 442 may also include cell group information which correspond to a group or rank of a cell or a base station associated therewith. For example, the cell group information indicates a group or rank of a cell, and such as a priority level, a high priority group, a low priority group, a mobility priority group, or a stationary group. For example, a cell belonging to the mobility priority group may indicate that the cell is prioritized for the positioning measurements of a UE with high mobility. Additionally, or alternatively, a cell belonging to the mobility priority group may indicate that the cell is also prioritized for the positioning measurements of a stationary UE. In another example, the cell belonging to the mobility priority group may indicate that it is not prioritized for stationary UEs so as to have more bandwidth for UEs with high and/or low mobility.

The cell priority information 442 may be determined based on characteristics of the cell, such as characteristics of the base station associated therewith. To illustrate, a cell with a base station that is designed to serve high speed devices may have more advanced equipment, a more advantageous position to serve devices over greater distances, etc. Such a cell and base station may be assigned a higher priority level in general, and/or a higher priority level for certain situations and/or certain UEs, such as for handling UEs that move quickly, handling UEs that are more advanced (e.g., more antennas, higher processing precision, low latency, etc.), or both. As another example, a cell, or associated base station, of a certain type, such as a high speed cell, may be assigned higher priority for mobility scenarios, as compared to other types of cells, and associated base stations. Additionally, a base station associated with a cell that is of a current or newer generation, may be assigned higher priority than cells with base stations of older or previous generations.

The cell priority information 442 may include multiple types of priority information, such as priority information for certain types of UEs, for certain states of motion of UEs, for uplink or SRS determination, for downlink or PRS determination, or any combination thereof. The cell priority information 442 may be associated with the cell list information, such as by being associated with one or more cells indicated by the cell list information and providing one or more priority indications for the one or more cells of the cell list information. The cell priority information 442 may be used by UEs and/or network devices to determine which reference signals to measure, that is which base stations it should transmit to and/or monitor.

As an illustrative example, when the cell priority information indicates rank information for a particular cell for mobility scenarios, a device may prioritize cells with a rank above a first threshold for measurement of UEs determined to be slow moving and may prioritize cells with a rank above a second threshold (e.g., higher than the first) for measurement of UEs determined to be fast moving. With such a prioritization scheme, the device may then use or revert to using cells with a rank below the first threshold for stationary UEs, and the network can serve more mobile UEs from cells that are better equipped to handle such mobility scenarios.

As another illustrative example, when the cell priority information indicates type information for a particular cell for mobility scenarios, a device may prioritize cells with a first type for advanced UEs (e.g., laptops, current generation and/or flagship cellular phones, etc.), prioritize cells with a second type for regular UEs (e.g., standard or previous generation cellular phones), and prioritize cells with a third type for reduced capability UEs (e.g., IoT UEs). With such a prioritization scheme, the device may serve higher performance UEs from higher performing cells. Although two general examples are provided above, the cell priority information 442 may include multiple types of priority information for different operating scenarios.

The positioning information 444 includes or corresponds to data associated with or corresponding to feedback for PRS and/or SRS transmissions indicating a UE position, a position of a UE. For example, the positioning information 444 may include measurement information determined from performing measurements on a PRS transmission, an SRS transmission, or both, and which indicates the UE position. The positioning information 444 may also indicate the cell associated with the PRS or SRS transmission and/or associated with the measurement of the PRS or SRS transmission.

In some implementations, the positioning information 444 includes measurement information. The measurement information includes or corresponds to data indicating or corresponding to position reference measurements. For example, the measurement information may include data indicating position related measurements for a reference signal, such as a PRS, a SRS, or both. To illustrate, the measurement information may include signal strength or quality measurements, such as RSRP, RSRQ, RSSI, etc. Additionally, or alternatively, the measurement information may include directionality-related measurement information, such as angle or arrival (AoA) or beam information, time-related measurement information, or a combination thereof. The time-related measurement information may include timing based measurements, such as time of arrival (TOA), TDOA and/or RSTD measurements, round trip time (RTT) measurements such as Rx-Tx measurements, or both, in some implementations.

Additionally, or alternatively, the positioning information 444 includes or indicates a position of the UE 115 determined from or based on the measurement information. For example, the positioning information 444 may indicate the position of the UE directly, which was determined using the measurement information, in addition to or in the alternative of including the measurement information.

In some implementations, the positioning information 444 includes positioning report or feedback data (e.g., PRS report data and/or SRS report data). The positioning report or feedback data includes or corresponds to data associated with or corresponding to feedback for PRS or SRS transmissions. For example, the positioning report data may indicate measurement information determined from performing measurements on a PRS/SRS transmission and/or a determined position (which was determined based on the measurement information). The positioning report data (e.g., PRS report data and/or SRS report data) may also indicate the cell or cells used to determine the measurement data and/or PRS/SRS report. Additionally, or alternatively, the positioning report or feedback data includes PRS/SRS report data or data for reporting measurements from another reference signal.

The settings data 446 includes or corresponds to data associated with enhanced positioning operations. The settings data 446 may include PRS settings data for PRS transmissions and PRS reporting, SRS settings data for SRS transmissions and SRS reporting, or both. For example, the settings data 446 may have data indicating transmission resources for reference signal transmissions and reporting transmissions. As another example, the settings data 446 may include data indicating a reporting format and/or an antenna configuration report type. To illustrate, the antenna configuration may be appended to or embedded in the report and/or may be explicitly included in or indicated by an index.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both, may include or correspond to one or more components of UE 115 described with reference to FIG. 2.

Encoder 413 and decoder 414 may be configured to encode and decode data for transmission. Positioning manager 415 may be configured to determine and perform positioning determination operations. For example, positioning manager 415 is configured to determine what resource or resources to use for PRS and/or SRS transmission and PRS and/or SRS feedback, such as when and where to perform reference signal transmissions and feedback transmissions therefore. As another example, positioning manager 415 is configured to perform measurement operations on PRS and/or SRS transmissions. In some implementations, positioning manager 415 is configured to determine whether to perform one measurement operation or multiple measurement operations, such as first and second measurement operations. The positioning manager 415 may be configured to include cell priority information and/or cell selection in a positioning report.

Cell priority manager 416 may be configured to determine and perform cell priority operations. For example, the cell priority manager 416 may be configured to determine a priority for one or more cells. To illustrate, the cell priority manager 416 may be configured to generate cell priority information, such as cell priority information 442. In some implementations, the cell priority manager 416 may be further configured to generate the cell priority information based on the cell type information which indicates a type of the cell, and optionally based on the UE information 406. As another example, the cell priority manager 416 may be configured to determine which cell or cells to measure based on the cell priority information, such as cell priority information 442. To illustrate, the cell priority manager 416 may be configured to select which cell or cells to transmit SRS transmissions to for SRS measurement and/or which cell or cells to monitor for PRS transmissions based on the cell priority information 442, and optionally based on the UE information 406.

Base station 105 includes processor 430, memory 432, transmitter 434, receiver 436, encoder 437, decoder 438, positioning manager 439, cell priority manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store data, such as UE information 406, cell list information 408, cell priority information 442, positioning information 444, settings data 446, or a combination thereof, as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both, may include or correspond to one or more components of base station 105 described with reference to FIG. 2.

Encoder 437, and decoder 438 may include the same functionality as described with reference to encoder 413 and decoder 414, respectively. Positioning manager 439 may include similar functionality as described with reference to positioning manager 415. Cell priority manager 440 may include similar functionality as described with reference to cell priority manager 416.

The network entity 405 may include similar components and functionality as the base station 105. In some implementations, the network entity 405 is collocated with or part of the base station 105. In other implementations, the network entity 405 is separate and distinct from the base station 105. The network entity 405 may include or correspond to a location server, such as positioning service entity. In some implementations, the network entity 405 includes or corresponds to a location management function (LMF), and the LMF may include the positioning manager 439 and/or the cell priority manager 440 and perform certain positioning or location functions for the network and base station 105.

During operation of wireless communications system 400, base station 105 and/or network entity 405 may determine that UE 115 has an enhanced positioning operation capability. For example, base station 105 may transmit a message 448 that includes an enhanced positioning indicator 490 (e.g., a cell priority capability indicator). Indicator 490 may indicate an enhanced positioning operation capability for positioning determination with cell priority information or a particular type or mode of enhanced positioning operation. In some implementations, a network entity (e.g., a network entity 405) or base station 105 sends control information to indicate to UE 115 that enhanced positioning operations and/or a particular type of enhanced positioning operation is to be used. For example, in some implementations, message 448 (or another message, such as configuration transmission 450) is transmitted by the base station 105 or the network entity 405. The configuration transmission 450 may include or indicate to use enhanced positioning determination operations or to adjust or implement a setting of a particular type of enhanced positioning determination operation. For example, the configuration transmission 450 may include settings data 446, as indicated in the example of FIG. 4.

During operation, devices of wireless communications system 400, perform enhanced positioning determination operations. For example, the wireless communication devices (e.g., a base station and UE) exchange transmissions via a downlink or uplink channel, or the wireless communication devices (e.g., two UEs) exchange transmissions via a sidelink channel.

In the example of FIG. 4, the UE 115 transmits UE information 406 to the network entity 405 and optionally the base station 105. For example, the UE 115 transmits a UE information transmission 452, including the UE information 406, to the network entity 405 via the base station 105. The UE information transmission 452 may include or correspond to assistance information transmission and the UE information 406 thereof may include or correspond to assistance information. In some implementations, the UE information transmission 452 is a PUSCH transmission or a positioning protocol transmission.

The network entity 405 generates the cell priority information 442 based on the UE information 406, and optionally based on cell information (e.g., cell type information) received from the base station 105. For example, network entity 405 generates the cell priority information 442 based on UE type information and/or UE state of motion information of the UE information 406, and based on cell type information received from the base station 105 indicating a type of cell associated with the base station 105 (e.g., served by the base station 105).

The network entity 405 transmits the cell list information 408 and the cell priority information 442 to the base station 105, the UE 115, or both, in a cell information transmission 454. For example, the network entity 405 may transmit the cell priority information 442 to the UE 115 via the base station 105. The cell priority information 442 may be included in a downlink transmission, such as PDSCH transmission or in a positioning protocol transmission, such as a LPP or NR Positioning Protocol A (NRPPa) transmission. Alternatively, the network entity 405 transmits the cell list information 408 and the cell priority information 442 in separate transmissions in other implementations.

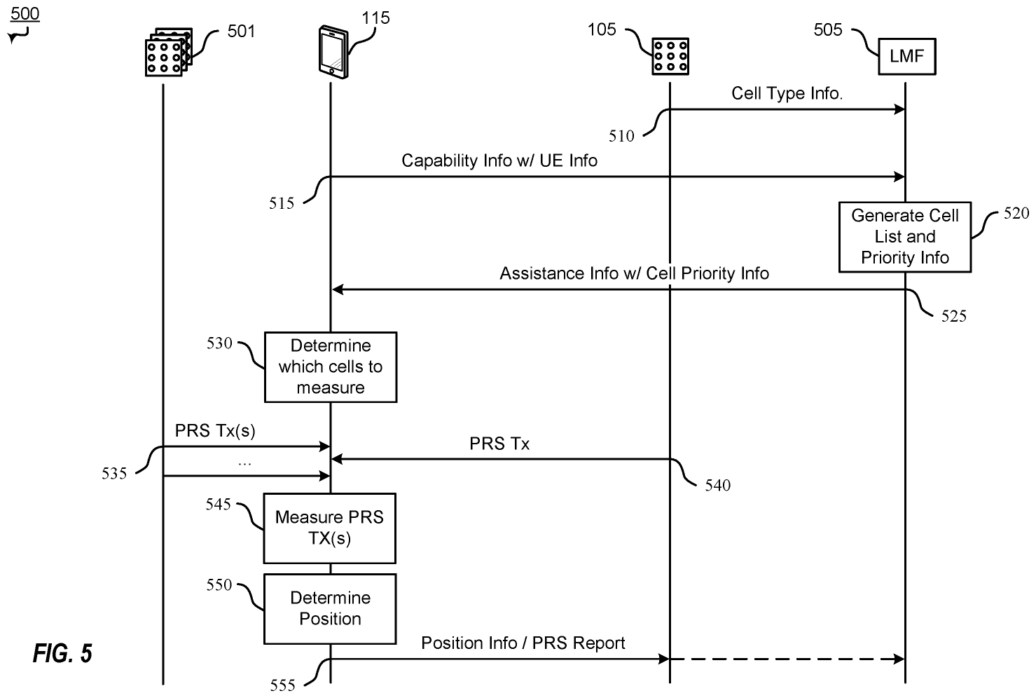

The base station 105 and the UE 115 may communicate one or more reference signal transmissions 456 based on the cell priority information 442. For example, the base station 105 may transmit one or more SRS transmissions to the UE 115 based on the cell priority information 442, and/or the UE 115 may transmit one or more PRS transmissions to the base station 105 based on the cell priority information 442, as described further with reference to FIGS. 5-8. To illustrate, a device may select which cells (and accordingly the associated base station) to use for reference signal measurement from the cell list based on the cell priority information and the UE information. As an illustrative, non-limiting example, an advanced UE with a high degree of motion, as indicated by the UE information 406, may be instructed to use a particular group of cells based on the cell priority information, and the particular group of cells may be associated with advanced UEs, with UEs with a high degree of motion, or both. To illustrate, the particular group of cells may have advanced hardware or capabilities to serve advanced UEs and/or with UEs with a high degree of motion, may be placed in an advantageous position (e.g., higher altitude, clearer sight lines, etc.) to serve advanced UEs and/or with UEs with a high degree of motion, or both.

The base station 105, the UE 115, or the network entity 405, may determine positioning information based on at least one of the one or more reference signal transmissions 456. For example, the base station 105 may determine positioning information based on the one or more SRS transmissions from the UE 115, and the UE 115 may determine positioning information based on the one or more PRS transmissions from the base station 105. To illustrate, the devices may determine measurement information based on the reference signal transmissions and the determine position information based on determined measurement information, or alternatively based on received measurement information that was measured by another device, as further described with reference to FIGS. 5-8.

The base station 105, the UE 115, and/or the network entity 405, may communicate the positioning information to each other in one or more positioning transmissions, such as positioning information transmission 458. For example, the UE 115 may report the positioning information to the network, such as to the base station 105 and/or the network entity 405. As another example, the network entity 405 may report the positioning information to the base station 105 and the UE 115. The above examples and additional examples are described further with reference to FIGS. 5-8.

Additionally, or alternatively, the base station 105, the UE 115, and/or the network entity 405, may transmit other transmissions which are based on the determined and/or received positioning information. For example, the devices may use the positioning information it determines, the received positioning information from and determined by another device, or both, to operate within the network and to engage in the services of the network, and optionally to engage in other services (e.g., for internal applications or communications with other networks).

Accordingly, the UE 115 and base station 105 may be able to more effectively perform positioning determination operations by prioritizing cells for reference signal measurement operations based on cell priority information. Thus, FIG. 4 describes enhanced positioning determination operations with cell prioritization. Using enhanced positioning determination operations with cell prioritization may enable improvements when operating with in networks with multiple types of cells. Performing enhanced positioning determination operations with cell prioritization enables increased positioning accuracy and signal strength and thus, enhanced UE and network performance by increasing throughput and reducing errors and latency.

FIGS. 5-8 illustrate examples of ladder diagrams for enhanced positioning determination operations according to some aspects. The examples of FIGS. 5-8 include similar devices to the devices described in FIGS. 1, 2, and 4, such as UE 115 and base station 105. The devices, such as UE 115 and base station 105, of FIGS. 5-8 may include one or more of the components as described in FIGS. 2 and 4. In FIGS. 5-8, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate transmissions and receptions.

FIG. 5 is a ladder diagram 500 of UE-based (e.g., PRS-based) positioning determination operations with network-based generation of cell priority information according to some aspects. In the example of FIG. 5, the ladder diagram illustrates a UE and multiple network entities, such as base station 105 and LMF 505. Although the ladder diagram of FIG. 5 illustrates a network architecture where the base station 105 and LMF 505 are separate, that is not collocated, in other implementations the base station 105 and LMF 505 may be collocated or a single device.

Prior to 510, the network may transmit PRS configuration information to the UE 115. For example, the positioning manager 439 of the base station 105 (e.g., a gNB) generates and transmits a PRS configuration message to the UE 115 which includes the PRS configuration information (e.g., setting data 446). The PRS configuration information may include information for the PRS transmission itself, for a corresponding report, or both. The information may include settings, formats, transmission resources, etc. The PRS configuration message may include or correspond to a higher layer message, such as a layer 3 message. For example, the base station 105 generates a RRC message which indicates or includes the PRS configuration information. In some implementations, the PRS configuration message is sent to multiple UEs. In other implementations, the PRS configuration message is a PDCCH transmission, such as a DCI, or a MAC CE. Additionally, or alternatively, the PRS configuration message may schedule multiple PRS transmissions and/or reports (e.g., periodic or semi-static) or schedule/trigger a single PRS transmission and report (e.g., aperiodic). In some implementations, the LMF 505 may transmit the PRS configuration information to the UE 115 via the base station 105.

At 510, the base station 105 transmits cell type information to the LMF 505. For example, the base station 105 may transmit or provide cell type information indicating a type of the cell associated with the base station 105, such as served by the base station 105 to the LMF 505. The cell type information may include or correspond to a portion of the cell priority information 442 of FIG. 4, and optionally may be used to generate the cell priority information. The base station 105 may transmit the cell type information wirelessly or via a wired backhaul. The base station 105 may transmit the cell type information in a positioning protocol transmission, such as an NRPPa transmission.

At 515, the UE 115 transmits UE information to the LMF 505. For example, the UE 115 transmits UE type and/or UE motion information to the LMF 505 directly, e.g., in a positioning protocol transmission, such as an LPP transmission. Alternatively, UE 115 transmits UE type and/or UE motion information to the base station 105, e.g., using RRC, which relays, transmits, or provides, the UE type and/or UE motion information to the LMF 505 using NRPPa. The UE information may include or correspond to the UE information 406 of FIG. 4, and indicate a type of the UE 115 and/or a state of motion thereof.

At 520, the LMF 505 generates cell list information and cell priority information. For example, the LMF 505 generates the cell list information based on received cell type information or as conventionally know in the art, and LMF 505 generates the cell priority information for the cell list information (e.g., the cells thereof) based on the received cell type information and the received UE information. The LMF 505 may generate the cell priority information for a particular UE, a particular type of UE, a particular state of motion for a UE, or a combination of UE type and state of motion. To illustrate, the cell list information may be generic to all UEs, while the cell priority information may be specific to a particular UE or a particular subset of UEs which shares a common type, a common state of motion, a common approximate location (e.g., a common serving base station or common serving cell) or some combination of these.

At 525, the LMF 505 transmits assistance information to the UE 115 including the cell priority information and optionally the cell list information. For example, LMF 505 transmits assistance information to UE 115 directly (e.g., using LPP) or transmits the assistance information to the base station 105 (e.g., using NRPPa) which relays, transmit or provides, the assistance information to the UE 115 (e.g., using RRC). The assistance information may include or correspond to cell list information 408, the cell priority information 442, or both.

In some implementations, the LMF 505 transmits the cell list information and the cell priority information to the UE 115 in a single transmission, while in other implementations the LMF 505, base station 105, or a base station of base stations 501 transmits the cell list information in another, different transmission, such as conventionally known in the art. For example, the UE 115 may receive the cell list information separate from the cell priority information, such as upon connection or association with the network.

At 530, the UE 115 determines from which cells it should measure reference signals (e.g. PRS) based on the cell priority information. For example, the UE 115 selects one or more cells to measure from the cell list information based on the cell priority information. To illustrate, the cell priority manager 416 of the UE 115 may select the cells with a highest priority ranking or the UE 115 may select cells with certain characteristics based on the cell priority information (e.g., cell type information) and based on the UE information (e.g., UE type and/or UE motion state). For example, as mentioned above, the cell priority information 442 may include cell priority information indicating the type of each cell in the list of cells indicated by the cell list information 408, and when selecting the cells based on the cell type information, the UE 115 may select one or more cells of a certain type(s) indicated by the cell type information from the list of cells. In this manner, the UE 115 selects which reference signal(s) to measure based on which cell or cells it selects. As the cell priority information from the network may include ranking information or cell type information, the UE 115 may also utilize UE information to determine which cells to measure. In some implementations, the UE 115 may optionally provide an indication of which cells it determined to measure to the base stations and/or LMF.

Although the example of FIG. 5 illustrates that the LMF 505 transmits the cell priority information to the UE 115 and the UE 115 determines which cells to prioritize for PRS position determination operations, in other implementations the LMF 505 does not transmit the cell priority information to the UE 115, and the network instead determines which cells to prioritize for PRS and/or SRS position determination operations. In such implementations, the LMF 505 and/or the base stations of the network utilize the cell priority information, and optionally, the UE information, to prioritize cells for PRS and/or SRS position determination operations and to determine which cells the UE 115 should measure reference signals (e.g., PRS) from and which associated base stations should measure UL SRS transmissions from the UE 115. The network (e.g., LMF 505 or base stations thereof) may then schedule the PRS transmissions and/or reports, and/or the UL SRS transmission based on the determined prioritized cells.

At 535, the UE 115 monitors for and receives one or more PRS transmissions from one or more base stations of the base stations 501. For example, the UE 115 determines when a PRS transmission is scheduled to be transmitted by a base station of the base stations 501 corresponding to a particular cell of the selected cell or cells and monitors for incoming PRS transmissions at that time. In some implementations, such as when the UE 115 selects two or more cells for PRS measurement, the UE determines when to monitor for PRS transmission from two or more corresponding base stations of the base stations 501 that are associated with the two or more selected cells.

At 540, the UE 115 monitors for and receives a PRS transmission from the base station 105. In some implementations the UE 115 may select the cell associated with the base station 105 for PRS measurement in addition to or as an alternative to selecting a cell or cells associated with base stations 501. The UE 115 may similarly determine when a PRS transmission is scheduled to be transmitted by the base station 105 corresponding to a particular selected cell of the selected cells and monitors for incoming transmissions at that time, including a PRS transmission.

Additionally, or alternatively, as compared to the above illustrative examples which illustrate selection of one or more cells (and corresponding base station) for measurement and reception of a single instance of a PRS transmission from the selected cell or cells, the UE 115 may monitor for and receive multiple PRS transmission from a selected cell or cell for measurement to increase positioning determination accuracy and/or determine UE motion.

At 545, the UE 115 measures the received PRS transmissions from the base station(s) and generates measurements. For example, the positioning manager 415 of the UE 115 processes and measures the PRS transmission(s) from the base station 105, base stations of the base stations 501, or a both, to generate measurement information. The UE 115 may measure or evaluate the PRS transmission using a single signal path or multiple signal paths. Measuring or evaluating the PRS transmission for multiple signal paths may include determining multiple measurements for a single PRS transmission.

At 550, the UE 115 may determine a position for the UE 115 based on the measurement information. For example, the UE 115 may determine position information based on the measurement information. For example, the positioning manager 415 of the UE 115 may determine a position of the UE 115 based on the measurement information, and optionally based on positioning assistance information, such as information which indirectly indicate the position (e.g., TOA/RTT).

At 555, the UE 115 provides position information for the UE 115 to one or more devices. For example, the UE 115 transmits a PRS report (e.g., positioning information transmission 458) based on the PRS measurement operations to the network, to other UEs, or a combination thereof. To illustrate, the positioning manager 415 of the UE 115 generates and transmits a PRS report message, optionally including an indication of the selected cells or reference signals it measured, to the base station 105, the LMF 505, or both. The PRS report message may include the measurement information, the determined position, or both. In some implementations, the UE 115 transmits a PUSCH or a positioning protocol transmission, which may include the position or measurement information, to the LMF 505 via the base station 105.

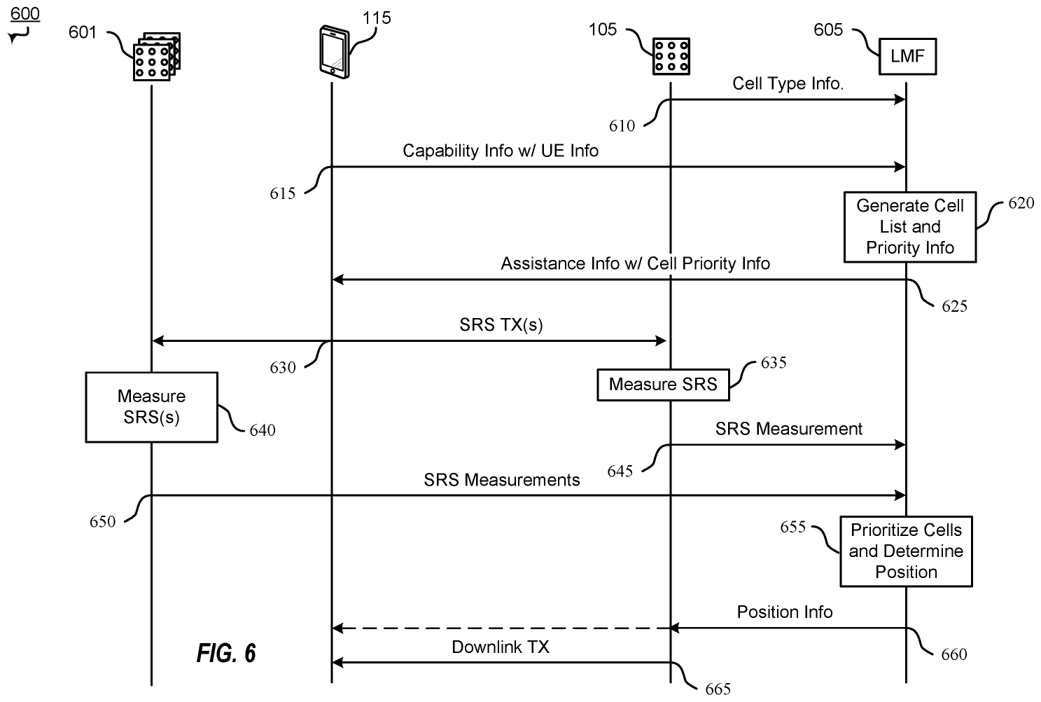

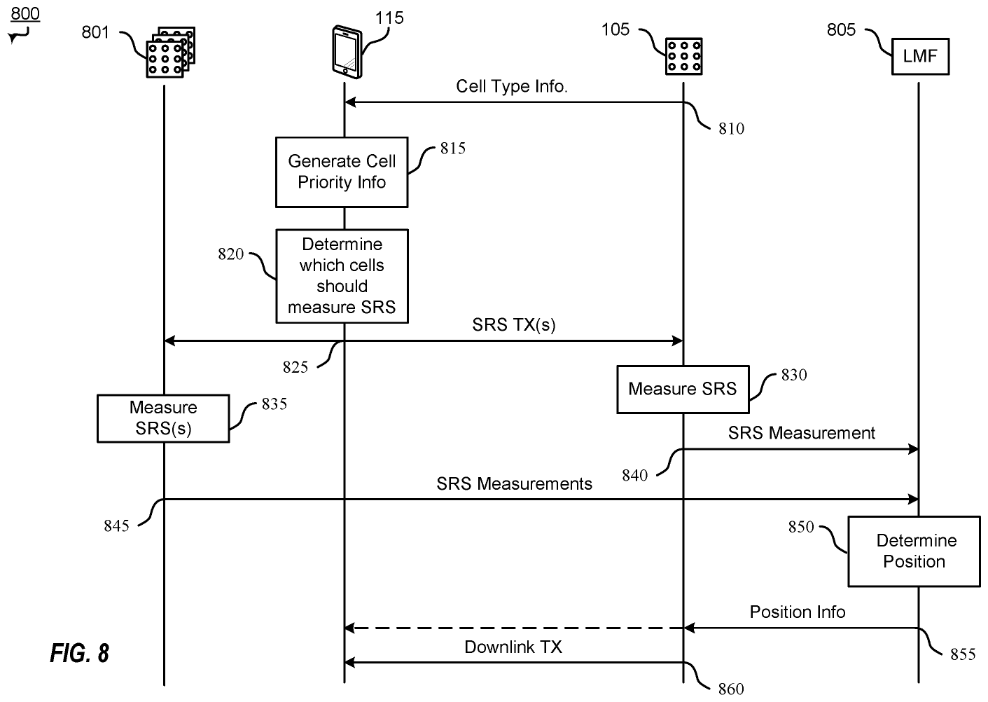

The PRS report of the PRS report message may be generated and transmitted based on the PRS configuration information. For example, the timing and structure of the PRS report may be determined based on the PRS configuration information. The PRS report message may include or correspond to a higher layer message, such as a layer 3 message. For example, the UE 115 generates a LPP message which includes the PRS measurement report. In other implementations, the PRS report is a PUCCH transmission, such as an uplink control information (UCI), a PUSCH transmission, or a MAC CE. Alternatively, for sidelink operations where the UE 115 receives a PRS from another UE, the PRS report may be a SCI or a MAC CE. The network devices may optionally use the position information, the measurements or determined position, as described with reference to FIGS. 6 and 8.

Thus, in the example in FIG. 5, the devices perform enhanced UE- or PRS-based positioning determination with cell priority information, where the cell priority information is generated by the network. Accordingly, the enhanced positioning determination with cell prioritization enables increased positioning accuracy and thus, enhanced UE and network performance by increasing signal accuracy and strength and reducing errors and latency.

FIG. 6 is a ladder diagram 600 of network-based (e.g., SRS-based) positioning determination operations with network-based generation of cell priority information according to some aspects. In the example of FIG. 6, the ladder diagram illustrates a UE 115 and multiple network entities, such as base station 105 and LMF 605. Although the ladder diagram of FIG. 6 illustrates a network architecture where the base station 105 and LMF 605 are separate, that is not collocated, in other implementations the base station 105 and LMF 605 may be collocated or integrated into a single device.

Prior to 610, the network may transmit SRS configuration information to the UE 115. For example, the positioning manager 439 of the base station 105 (e.g., a gNB) generates and transmits an SRS configuration message to the UE 115 which includes the SRS configuration information (e.g., setting data 446). The SRS configuration information may include information for the SRS transmission itself, for a corresponding report, or both. The information may include settings, formats, transmission resources, etc. The SRS configuration message may include or correspond to a higher layer message, such as a layer 3 message. For example, the base station 105 generates a RRC message which indicates or includes the SRS configuration information. In some implementations, the SRS configuration message is sent to multiple UEs. In other implementations, the SRS configuration message is a PDCCH transmission, such as a DCI, or a MAC CE. Additionally, or alternatively, the SRS configuration message may schedule multiple SRS transmissions and/or reports (e.g., periodic or semi-static) or schedule/trigger a single SRS transmission and report (e.g., aperiodic). In some implementations, the LMF 605 may transmit the SRS configuration information to the UE 115 via the base station 105.

At 610, the base station 105 transmits cell type information to the LMF 605. For example, the base station 105 may transmit or provide cell type information indicating a type of the cell associated with the base station 105, such as served by the base station 105 to the LMF 605. The cell type information may include or correspond to a portion of the cell priority information 442 of FIG. 4, and optionally may be used to generate the cell priority information. The base station 105 may transmit the cell type information wirelessly or via a wired backhaul. The base station 105 may transmit the cell type information in a positioning protocol transmission, such as an NRPPa transmission.

At 615, the UE 115 transmits UE information to the LMF 605. For example, the UE 115 transmits UE type and/or UE motion information either directly to the LMF 605 (e.g., using LPP), or to the base station 105 (e.g., using RRC) which relays, transmits, or provides, the UE type and/or UE motion information to the LMF 605 (e.g., using NRPPa). The UE information may include or correspond to the UE information 406 of FIG. 4, and indicate a type of the UE 115 and/or a state of motion thereof.

At 620, the LMF 605 generates cell list information and cell priority information. For example, the LMF 605 generates the cell list information based on received cell type information or as conventionally known in the art, and LMF 605 generates the cell priority information for the cell list information (e.g., the cells thereof) based on the received cell type information and the received UE information. The LMF 605 may generate the cell priority information for a particular UE, a particular type of UE, a particular state of motion for a UE, or a combination of UE type and state of motion. To illustrate, the cell list information may be generic to all UEs, while the cell priority information may be specific to a particular UE or a particular subset of UEs which shares a common type, a common state of motion, a common approximate location (e.g., a common serving base station or common serving cell), or some combination of these.

At 625, the LMF 605 transmits assistance information to the UE 115 including the cell priority information and optionally the cell list information. For example, LMF 605 transmits assistance information to the base station 105 which relays, transmit or provides, the assistance information to the UE 115. The LMF 605 and/or the base station 105 may transmit the assistance information in a positioning protocol transmission, such as a LPP or NRPPa transmission. The assistance information may include or correspond to cell list information 408, the cell priority information 442, or both.

In some examples, the LMF 605 transmits the cell list information and the cell priority information to the UE 115 in a single transmission, while in other examples the LMF 605, base station 105, or a base station of base stations 601 transmits the cell list information in another, different transmission, such as conventionally known in the art. For example, the UE 115 may receive the cell list information separate from the cell priority information, such as upon connection or association with the network.

In some implementations, the UE 115 optionally determines which cells should measure reference signals from the UE 115 based on the cell priority information. For example, similar to the UE determination at 530 of FIG. 5, the UE 115 may determine which cells should measure its positioning reference signals (e.g., SRS transmissions) based on the cell priority to enable higher performance or high performing cells for the type and state of motion of the UE 115 to measure its reference signals. In such implementations, the UE 115 may indicate its selection to the selected cells (e.g., base stations associated with the cells) or to the LMF 605 so that that network, either the base stations or LMF 605, can schedule the SRS transmissions for position measurement for the UE 115.

Additionally, or alternatively, the LMF 605 transmits the assistance information to the base station 105, the base stations 601, or both. For example, the LMF 605 transmits the cell priority information to the base stations so that the base stations can also determine which cells and corresponding base stations should measure SRS transmission from the UE 115. Providing the cell priority information for all UEs or for the UE 115 may enable the base stations to determine and/or select which cells and corresponding base stations should measure the SRS transmissions from the UE 115 and to engage in SRS scheduling transmission or the SRS transmissions.

Although the example of FIG. 6 illustrates that the LMF 605 transmits the cell priority information to the UE 115, in other implementation the LMF 605 does not transmit the cell priority information to the UE 115. In such implementations, the LMF 605 and/or the base stations of the network utilize the cell priority information, and optionally, the UE information, to prioritize cells and/or base stations for SRS position determination operations and determine which cells and associated base stations should measure SRS transmissions from the UE 115. The network may prioritize cells for SRS position determination operations in a manner similar to the above explained with reference to the UE 115.

At 630, the UE 115 transmits one or more SRS transmissions to one or more base stations. For example, the UE 115 transmits one or more SRS transmissions to the base station 105, one or more base stations of base stations 601, or a combination thereof, based on the selected base stations, selected based on the cell priority information. To illustrate, the UE 115 may broadcast an SRS transmission to multiple base stations, or the UE may transmit multiple unicast SRS transmissions to each base station of the selected base stations. The SRS transmissions may be included in a PUSCH or PUCCH transmission. The SRS transmissions may be requested by the UE 115 in a separate uplink transmission, and/or granted or scheduled by the network in a separate downlink transmission, as conventionally known in the art and not shown in FIG. 6. Additionally, or alternatively, the UE 115 may already be configured with grants or resources for uplink and/or SRS transmission and may utilize such resources for the SRS transmission or SRS transmissions.

At 635, the base station 105 measures an SRS transmission from the UE 115 and generates measurements. For example, the positioning manager 439 of the base station 105 processes and measures the SRS transmission(s) from the UE 115 to generate measurement information. The base station 105 may measure or evaluate the SRS transmission using a single signal path or multiple signal paths. Measuring or evaluating the SRS transmission for multiple signal paths may include determining multiple measurements for a single SRS transmission.

At 640, the base stations 601 measure SRS transmissions from the UE 115 and generate measurements. For example, a positioning manager of one or more base stations of base stations 601 processes and measures the SRS transmission(s) from the UE 115 to generate measurement information. The base station may measure or evaluate the SRS transmission using a single signal path or multiple signal paths. Measuring or evaluating the SRS transmission for multiple signal paths may include determining multiple measurements for a single SRS transmission.

At 645, the base station 105 transmits measurement information to the LMF 605. For example, the positioning manager 439 of the base station 105 transmits the measurement information for the measured SRS transmission(s) from the UE 115 to the LMF 605. To illustrate, the positioning manager 439 of the base station 105 transmits or provides an SRS report or a positioning protocol transmission to LMF 605. The measurement information may be transmitted wirelessly or via a wired backhaul, or provided internally or locally for a co-located LMF.

At 650, the base stations 601 transmit measurement information to the LMF 605. Similarly, one or more base stations of the base stations 601 which received and measured SRS transmissions from the UE 115 may provide the corresponding measurement information to the LMF 605. For example, a positioning manager of a base station of the base stations 601 transmits the measurement information for the measured SRS transmission(s) from the UE 115 to the LMF 605. To illustrate, the positioning manager of the base station transmits or provides an SRS report or a positioning protocol transmission to LMF 605. The measurement information may be transmitted wirelessly or via a wired backhaul, or provided internally or locally for a co-located LMF.

At 655, the LMF 605 prioritizes cells for measurement of SRS transmissions and determines a position for the UE 115 based on received measurement information. For example, the LMF 605 prioritizes cells for measurement of SRS transmissions from the UE 115 based on the UE information from the UE 115 and/or based on the cell type information from one or more base stations, such as base station 105 and/or base stations 601. To illustrate, a cell priority manager (e.g., the cell priority manager 440) of the LMF 605 may determine to select high speed cells of the cell list to measure SRS transmissions from the UE 115 based on UE motion information indicating that the UE 115 is moving at a high rate of speed, and then may identify and prioritize the selected high speed cells of the cell list for SRS measurement based on the cell type information. Additionally, or alternatively, the LMF 605 may determine to select particular cells or types of cells of the cell list to measure SRS transmissions from the UE 115 based on the UE type information of the UE information. To illustrate, the cell priority manager (e.g., the cell priority manager 440) of the LMF 605 may determine to select the high speed cells of the cell list to measure SRS transmissions from the UE 115 based on UE type information indicating that the UE 115 is a non-stationary UE, an advanced UE (e.g., multiple antennas and/or radios), etc.

Although cell prioritization operations are illustrated as occurring temporally with position determination operations and after SRS transmission and measurement operations, the cell prioritization operations for SRS measurement at 655 may occur prior to SRS transmission and measurement in some implementations, e.g., may occur as part of the LMF 605 generating the cell list information and cell priority information at 620. For example, the LMF 605 may prioritize and select the cells for measuring the SRS transmissions shortly after and then schedule the SRS transmissions, instruct the selected cells (e.g., base stations associated thereof) to schedule the SRS transmissions, or instruct the UE 115 to schedule the SRS transmissions. The scheduling of SRS transmissions may be performed as conventionally known in the art, such as by downlink scheduling or triggering for the SRS transmissions.

The LMF 605 determines position information for the UE 115 based on the received SRS measurement information from one or more base stations. To illustrate, a positioning manager (e.g., the positioning manager 439) of the LMF 605 may determine a position of the UE 115 based on the measurement information, and optionally based on positioning assistance information, such as information which indirectly indicate the position (e.g., TOA/RTT).

In other implementations, the LMF 605 may prioritize the cells after transmission of the SRS transmissions. For example, multiple cells (e.g., base stations associated therewith) measure the SRS transmissions from the UE 115 and provide the resulting measurement information to the LMF 605. The LMF 605 may then prioritize or select which measurements to use (which measurement information) based on the UE information from the UE 115 and based on the cell type information from one or more base stations, as described above. To illustrate, the LMF 605 may receive measurement information from ten base stations associated with ten cells, and the LMF 605 may determine to prioritize four of the ten cells for positioning determination based on the cells being associated with high speed cells, and the LMF 605 may then utilize measurement information corresponding to the four selected cells for position determination. The LMF 605 may refrain from utilizing the measurement information from the six unselected cells.

At 660, the LMF 605 provides position information for the UE 115 to one or more devices. For example, the LMF 605 transmits an SRS report based on the SRS measurement operations to the network, to the UE 115, to other UEs, or a combination thereof. To illustrate, a positioning manager of the LMF 605 generates and transmits an SRS report message to the UE 115. The SRS report message may include the measurement information, the determined position, or both. In some implementations, the LMF 605 transmits a PDSCH or a positioning protocol transmission, which may include the position or measurement information, to the UE 115 via the base station 105.

The devices of the network may optionally use the received position. For example, at 665, the base station 105 transmits a transmission to the UE 115 based on the received position information for the UE 115. To illustrate, the base station 105 transmits a downlink transmission to the UE 115 based on the received position information for the UE 115. Because the position determined for the UE 115 was determined based on higher performance or higher performing cells and reference signals, the position may be more accurate and provide enhanced location services and a better network and user experience due to reduce transmission and link failures.

Additionally, or alternatively, the devices of the network use the determined position for the UE 115 in other ways. For example, the UE 115 may use the determined position for other services, applications, for device-to-device communications, and/or for communications with other networks.

Thus, in the example in FIG. 6, the devices perform enhanced network- or SRS-based positioning determination with cell priority information, where the cell priority information is generated by the network. Accordingly, the enhanced positioning determination with cell prioritization enables increased positioning accuracy and thus, enhanced UE and network performance by increasing signal accuracy and strength and reducing errors and latency.

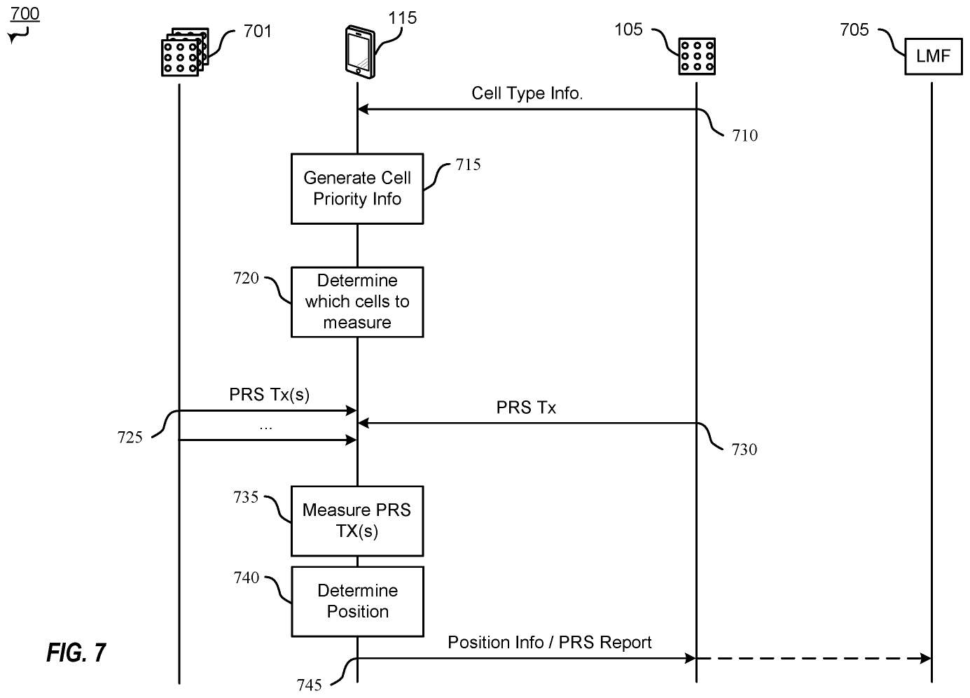

FIG. 7 is a ladder diagram 700 of UE-based (e.g., PRS-based) positioning determination operations with UE-based generation of cell priority information according to some aspects. In the example of FIG. 7, the ladder diagram illustrates a UE 115 and multiple network entities, such as base station 105 and LMF 705. Although the ladder diagram of FIG. 7 illustrates a network architecture where the base station 105 and LMF 705 are separate, that is not collocated, in other implementations the base station 105 and LMF 705 may be collocated or integrated into a single device. As compared to the operations of the examples of FIGS. 5 and 6 for network determined cell priority information, the examples of FIGS. 7 and 8 correspond to examples where a UE determines the cell priority information.

Prior to 710, the network may transmit PRS configuration information to the UE 115. For example, the positioning manager 439 of the base station 105 (e.g., a gNB) generates and transmits a PRS configuration message to the UE 115 which includes the PRS configuration information (e.g., setting data 446). The PRS configuration information may include information for the PRS transmission itself, for a corresponding report, or both. The information may include settings, formats, transmission resources, etc. The PRS configuration message may include or correspond to a higher layer message, such as a layer 3 message. For example, the base station 105 generates a RRC message which indicates or includes the PRS configuration information. In some implementations, the PRS configuration message is sent to multiple UEs. In other implementations, the PRS configuration message is a PDCCH transmission, such as a DCI, or a MAC CE. Additionally, or alternatively, the PRS configuration message may schedule multiple PRS transmissions and/or reports (e.g., periodic or semi-static) or schedule/trigger a single PRS transmission and report (e.g., aperiodic). In some implementations, the LMF 705 may transmit the PRS configuration information to the UE 115 via the base station 105.

At 710, the base station 105 transmits cell type information to the UE 115. For example, the base station 105 may transmit or provide cell type information indicating a type of the cell associated with the base station 105, such as served by the base station 105 to the UE 115. The cell type information may include or correspond to a portion of the cell priority information 442 of FIG. 4, and optionally may be used to generate the cell priority information. The base station 105 may transmit the cell type information in a positioning protocol transmission, such as an LPP or NRPPa transmission. In some implementations, the base station 105 provides cell type information for multiple base stations, such as for the base station 105 and one or more base stations of the base station 701 to enable the UE 115 to generate cell priority information for multiple cells of the cell list. In other implementations, multiple base stations, such as one or more base stations of the base station 701 provide cell type information for themselves to the UE 115 to enable the UE 115 to generate cell priority information for multiple cells of the cell list.

Alternatively, in other implementations the base station 105 and one or more base stations of the base stations 701 may transmit the cell type information to the LMF 705 for aggregation, and the LMF 705 provides aggregated cell type information to the UE 115, such as via the base station 105.

At 715, the UE 115 generates cell priority information. For example, the UE 115 generates the cell priority information based on the received cell type information and UE information regarding the UE 115 for received cell list information. The cell priority indicates a measurement priority for the UE 115 for one or more cells of the cell list information. To illustrate, the cell priority manager 416 of the UE 115 generates the cell priority information for a particular UE, UE 115, regarding the cells of the cell list information based on a particular type of the UE 115, a particular state of motion for the UE 115, or a combination of the UE type and the state of motion. Thus, the cell list information may be generic to all UEs, while the cell priority information may be specific to the UE 115. As compared to the network generated cell priority examples of FIGS. 5 and 6, the UE generated cell priority information examples of FIGS. 7 and 8 reduce network processing and offload cell priority information generation to devices for generation of potentially more tailored cell priority, cell priority which better suits the type of UE and its state of motion.

Although not shown in FIG. 7, the UE 115 may receive cell list information from the network, such as from the base station 105 or the LMF 705, in a downlink communication as described with to FIGS. 4-6. The cell list information may be provided conventionally, such as open connection/association to the network.

At 720, the UE 115 determines which cells should measure reference signals from the UE 115 based on the cell priority information. For example, the UE 115 selects one or more cells to measure from the cell list information based on the cell priority information, similar to the UE determination at 530 of FIG. 5. To illustrate, the cell priority manager 416 of the UE 115 may select the cells with a highest priority ranking or the UE 115 may select cells with certain characteristics based on the cell priority information (e.g., cell type information) and based on the UE information (e.g., UE type and/or UE motion state). In this manner, the UE 115 selects which reference signal(s) to measure based on which cell or cells it selects. In some implementations, the UE 115 may optionally provide an indication of which cells it determined to measure to the base stations and/or LMF. Additionally, or alternatively, the UE 115 may optionally provide the generated cell priority information to the base stations and/or LMF, such as part of AI/ML feedback process or as indication or which cells it will measure or which cells it is likely to measure.

Although the example of FIG. 7 illustrates that the UE 115 determines which cells to prioritize for PRS position determination operations, in other implementations the UE 115 may provide the cell priority information to the network and the network determines which cells to prioritize for PRS position determination operations. In such implementations, the LMF 705 and/or the base stations of the network utilize the cell priority information received from the UE 115, and optionally, the UE information, to prioritize cells for PRS position determination operations and determine which cells should measure PRS transmissions from the UE 115. The network (e.g., LMF 705 or base stations thereof) may then schedule the PRS transmission based on the determined prioritized cells.

At 725, the UE 115 monitors for and receives one or more PRS transmissions from one or more base stations, base stations 701. For example, the UE 115 determines when a PRS transmission is scheduled to be transmitted by a base station of the base stations 701 corresponding to a particular cell of the selected cell or cells and monitors for incoming transmissions at that time. In some implementations, such as when the UE 115 selects two or more cells for PRS measurement, the UE the determines when to monitor for PRS transmission from two or more corresponding base stations of the base stations 701 that are associated with the two or more selected cells.

At 730, the UE 115 monitors for and receives a PRS transmission from the base station 105. In some implementations the UE 115 may select the cell associated with the base station 105 for PRS measurement in addition to or in the alternative of selecting a cell or cells associated with base stations 701. The UE 115 may similarly determine when a PRS transmission is scheduled to be transmitted by the base station 105 corresponding to a particular selected cell of the selected cells and monitors for incoming transmissions at that time, including a PRS transmission.

Additionally, or alternatively, as compared to the above illustrative examples which illustrate selection of one or more cells (and corresponding base station) for measurement and reception of a single instance of a PRS transmission from the selected cell or cells, the UE 115 may monitor for and receive multiple PRS transmission from a selected cell or cell for measurement to increase positioning determination accuracy and/or determine UE motion.

At 735, the UE 115 measures the received PRS transmissions from the base station 105 and generates measurements. For example, the positioning manager 415 of the UE 115 processes and measures the PRS transmission(s) from the base station 105, base stations of the base stations 501, or a both, to generate measurement information. The UE 115 may measure or evaluate the PRS transmission using a single signal path or multiple signal paths. Measuring or evaluating the PRS transmission for multiple signal paths may include determining multiple measurements for a single PRS transmission.

At 740, the UE 115 determines a position for the UE 115 based on the measurement information. For example, the UE 115 determines position information based on the measurement information. For example, the positioning manager 415 of the UE 115 may determine a position of the UE 115 based on the measurement information, and optionally based on positioning assistance information, such as information which indirectly indicate the position (e.g., TOA/RTT).

At 745, the UE 115 provides position information for the UE 115 to one or more devices. For example, the UE 115 transmits a PRS report based on the PRS measurement operations to the network, to other UEs, or a combination thereof. To illustrate, the positioning manager 415 of the UE 115 generates and transmits a PRS report message, optionally including an indication of the selected cells or reference signals it measured, to the base station 105, the LMF 705, or both. The PRS report message may include the measurement information, the determined position, or both. In some implementations, the UE 115 transmits a PUSCH or a positioning protocol transmission, which may include the position or measurement information, to the LMF 705 via the base station 105.

The PRS report of the PRS report message may be generated and transmitted based on the PRS configuration information. For example, the timing and structure of the PRS report may be determined based on the PRS configuration information. The PRS report message may include or correspond to a higher layer message, such as a layer 3 message. For example, the UE 115 generates a LPP message which includes the PRS measurement report. In other implementations, the PRS report is a PUCCH transmission, such as an uplink control information (UCI), a PUSCH transmission, or a MAC CE. Alternatively, for sidelink operations where the UE 115 receives a PRS from another UE, the PRS report may be a SCI or a MAC CE. The network devices may optionally use the position information, the measurements or determined position, as described with reference to FIGS. 6 and 8.

Thus, in the example in FIG. 7, the devices perform enhanced UE- or PRS-based positioning determination with cell priority information, where the cell priority information is generated by the UE. Accordingly, the enhanced positioning determination with cell prioritization enables increased positioning accuracy and thus, enhanced UE and network performance by increasing signal accuracy and strength and reducing errors and latency.

FIG. 8 is a ladder diagram 800 of network-based (e.g., SRS-based) positioning determination operations with UE-based generation of cell priority information according to some aspects. In the example of FIG. 8, the ladder diagram illustrates a UE 115 and multiple network entities, such as base station 105 and LMF 805. Although the ladder diagram of FIG. 8 illustrates a network architecture where the base station 105 and LMF 805 are separate, that is not collocated, in other implementations the base station 105 and LMF 805 may be collocated or integrated into a single device.

Prior to 810, the network may transmit SRS configuration information to the UE 115. For example, the positioning manager 439 of the base station 105 (e.g., a gNB) generates and transmits an SRS configuration message to the UE 115 which includes the SRS configuration information (e.g., setting data 446). The SRS configuration information may include information for the SRS transmission itself, for a corresponding report, or both. The information may include settings, formats, transmission resources, etc. The SRS configuration message may include or correspond to a higher layer message, such as a layer 3 message. For example, the base station 105 generates a RRC message which indicates or includes the SRS configuration information. In some implementations, the SRS configuration message is sent to multiple UEs. In other implementations, the SRS configuration message is a PDCCH transmission, such as a DCI, or a MAC CE. Additionally, or alternatively, the SRS configuration message may schedule multiple SRS transmissions and/or reports (e.g., periodic or semi-static) or schedule/trigger a single SRS transmission and report (e.g., aperiodic). In some implementations, the LMF 805 may transmit the SRS configuration information to the UE 115 via the base station 105.

At 810, the base station 105 transmits cell type information to the UE 115. For example, the base station 105 may transmit or provide cell type information indicating a type of the cell associated with the base station 105, such as served by the base station 105 to the UE 115. The cell type information may include or correspond to a portion of the cell priority information 442 of FIG. 4, and optionally may be used to generate the cell priority information. The base station 105 may transmit the cell type information in a positioning protocol transmission, such as an LPP or NRPPa transmission. In some implementations, the base station 105 provides cell type information for multiple base stations, such as for the base station 105 and one or more base stations of the base station 801 to enable the UE 115 to generate cell priority information for multiple cells of the cell list. In other implementations, multiple base stations, such as one or more base stations of the base station 801 provide cell type information for themselves to the UE 115 to enable the UE 115 to generate cell priority information for multiple cells of the cell list.

Alternatively, in other implementations the base station 105 and one or more base stations of the base stations 801 may transmit the cell type information to the LMF 805 for aggregation, and the LMF 805 provides aggregated cell type information to the UE 115, such as via the base station 105.

At 815, the UE 115 generates cell priority information. For example, the UE 115 generates the cell priority information based on the received cell type information and UE information regarding the UE 115 for received cell list information. The cell priority indicates a measurement priority for the UE 115 for one or more cells of the cell list information. To illustrate, the cell priority manager 416 of the UE 115 generates the cell priority information for a particular UE, UE 115, regarding the cells of the cell list information based on a particular type of the UE 115, a particular state of motion for the UE 115, or a combination of the UE type and the state of motion. Thus, the cell list information may be generic to all UEs, while the cell priority information may be specific to the UE 115. As compared to the network generated cell priority examples of FIGS. 5 and 6, the UE generated cell priority information examples of FIGS. 7 and 8 reduce network processing and offload cell priority information generation to devices for generation of potentially more tailored cell priority, cell priority which better suits the type of UE and its state of motion.

Although not shown in FIG. 8, the UE 115 may receive cell list information from the network, such as from the base station 105 or the LMF 805, in a downlink communication as described with to FIGS. 4-6. The cell list information may be provided conventionally, such as open connection/association to the network.

At 820, the UE 115 determines which cells should measure reference signals from the UE 115 based on the cell priority information. For example, the UE 115 selects one or more cells to measure reference signals from the UE 115 from the cell list information based on the cell priority information. To illustrate, the cell priority manager 416 of the UE 115 may select the cells with a highest priority ranking or the UE 115 may select cells with certain characteristics based on the cell priority information (e.g., cell type information) and based on the UE information (e.g., UE type and/or UE motion state). In this manner, the UE 115 selects which cells (and corresponding base stations) should measure its reference signal(s) based on which cell or cells it selects. In some implementations, the UE 115 may optionally provide an indication of which cells it determined to measure its reference signals to the base stations and/or LMF. Additionally, or alternatively, the UE 115 may optionally provide the generated cell priority information to the base stations and/or LMF, such as part of AI/ML feedback process or as indication or which cells it will measure or which cells it is likely to measure.

In such implementations, the UE 115 may indicate its selection to the selected cells (e.g., base stations associated with the cells) or to the LMF 805 so that that network, either the base stations or LMF 805, can schedule the SRS transmissions for position measurement for the UE 115. Because the UE 115 determined which cells should measure its positioning reference signals (e.g., SRS transmissions) based on the cell priority, it enables higher performance or high performing cells for the type and state of motion of the UE 115 to measure its reference signals.

Additionally, or alternatively, the UE 115 transmits assistance information to the base station 105, the base stations 801, LMF 805, or a combination thereof. For example, the UE 115 transmits the cell priority information to the base stations so that the base stations can determine (or also determine) which cells and corresponding base stations should measure SRS transmission from the UE 115. As another example, the UE 115 transmits the cell priority information to the LMF 805 so that the LMF 805 can determine and schedule which base stations should measure SRS transmission from the UE 115 or so that the LMF 805 can distribute the cell priority information for the UE 115 to the applicable base stations. Providing the cell priority information for the UE 115 may enable the base stations to determine and/or select which cells and corresponding base stations should be prioritized to measure the SRS transmissions from the UE 115 and to engage in SRS scheduling transmission or the SRS transmissions.

At 825, the UE 115 transmits one or more SRS transmissions to one or more base stations. For example, the UE 115 transmits one or more SRS transmissions to the base station 105, one or more base stations of base stations 601, or a combination thereof, based on the selected base stations, selected based on the cell priority information. To illustrate, the UE 115 may broadcast an SRS transmission to multiple base stations, or the UE may transmit multiple unicast SRS transmissions to each base station of the selected base stations. The SRS transmissions may be included in a PUSCH or PUCCH transmission. The SRS transmissions may be requested by the UE 115 in a separate uplink transmission, and granted or scheduled by the network in a separate downlink transmission, as conventionally known in the art and not shown in FIG. 6. Additionally, or alternatively, the UE 115 may already be configured with grants or resources for uplink and/or SRS transmission and may utilize such resources for the SRS transmission or SRS transmissions.

At 830, the base station 105 measures an SRS transmission from the UE 115 and generates measurements. For example, the positioning manager 439 of the base station 105 processes and measures the SRS transmission(s) from the UE 115 to generate measurement information. The base station 105 may measure or evaluate the SRS transmission using a single signal path or multiple signal paths. Measuring or evaluating the SRS transmission for multiple signal paths may include determining multiple measurements for a single SRS transmission.

At 835, the base stations 801 measure SRS transmissions from the UE 115 and generate measurements. For example, a positioning manager of one or more base stations of base stations 801 processes and measures the SRS transmission(s) from the UE 115 to generate measurement information. The base station may measure or evaluate the SRS transmission using a single signal path or multiple signal paths. Measuring or evaluating the SRS transmission for multiple signal paths may include determining multiple measurements for a single SRS transmission.

At 840, the base station 105 transmits measurement information to the LMF 805. For example, the positioning manager 439 of the base station 105 transmits the measurement information for the measured SRS transmission(s) from the UE 115 to the LMF 805. To illustrate, the positioning manager 439 of the base station 105 transmits or provides an SRS report or a positioning protocol transmission to LMF 805. The measurement information may be transmitted wirelessly or via a wired backhaul, or provided internally or locally for a co-located LMF.

At 845, the base stations 801 transmit measurement information to the LMF 805. Similarly, one or more base stations of the base stations 801 which received and measured SRS transmissions from the UE 115 may provide the corresponding measurement information to the LMF 805. For example, a positioning manager of a base station of the base stations 801 transmits the measurement information for the measured SRS transmission(s) from the UE 115 to the LMF 805. To illustrate, the positioning manager of the base station transmits or provides an SRS report or a positioning protocol transmission to LMF 805. The measurement information may be transmitted wirelessly or via a wired backhaul, or provided internally or locally for a co-located LMF.

At 850, the LMF 805 determines a position for the UE 115 based on received measurement information. For example, the LMF 805 determines position information for the UE 115 based on the received SRS measurement information from one or more base stations. To illustrate, a positioning manager (e.g., the positioning manager 439) of the LMF 805 may determine a position of the UE 115 based on the measurement information, and optionally based on positioning assistance information, such as information which indirectly indicate the position (e.g., TOA/RTT).

In the example of FIG. 8, the UE 115 has selected which cells should measure the SRS transmissions from the UE 115 and may optionally provide the selection to the network. The LMF 805 then receives the measurement information, for the SRS transmissions from the UE 115, from the selected cells and determines the position information for the UE 115 based on the received measurement information.

In other examples, multiple cells may provide measurement information to the LMF 805, and the LMF 805 may prioritize the cells and select certain cells for positioning determination operations. To illustrate, the LMF 805 may receive priority information from the UE 115 or an indication of a selected or prioritized cells which were determined by the UE 115, and the LMF 805 may prioritize the received measurement information based on the received priority information or received indications of selected or prioritized cells. To illustrate, a cell priority manager (e.g., the cell priority manager 440) of the LMF 805 may determine to select high speed cells of the cell list to measure SRS transmissions from the UE 115 based on indications of prioritized cells determined by the UE 115.

At 855, the LMF 805 provides position information for the UE 115 to one or more devices. For example, the LMF 805 transmits an SRS report based on the SRS measurement operations to the network, to the UE 115, to other UEs, or a combination thereof. To illustrate, a positioning manager of the LMF 805 generates and transmits an SRS report message to the UE 115. The SRS report message may include the measurement information, the determined position, or both. In some implementations, the LMF 805 transmits a PDSCH or a positioning protocol transmission, which may include the position or measurement information, to the UE 115 via the base station 105.

The devices of the network may optionally use the received position. For example, at 860, the base station 105 transmits a transmission to the UE 115 based on the received position information for the UE 115. To illustrate, the base station 105 transmits a downlink transmission to the UE 115 based on the received position information for the UE 115. Because the position determined for the UE 115 was determined based on higher performance or higher performing cells and reference signals, the position may be more accurate and provide enhanced location services and a better network and user experience due to reduce transmission and link failures.

Additionally, or alternatively, the devices of the network use the determined position for the UE 115 in other ways. For example, the UE 115 may use the determined position for other services, applications, for device-to-device communications, and/or for communications with other networks.

Thus, in the example in FIG. 8, the devices perform enhanced UE- or PRS-based positioning determination with cell priority information, where the cell priority information is generated by the UE. Accordingly, the enhanced positioning determination with cell prioritization enables increased positioning accuracy and thus, enhanced UE and network performance by increasing signal accuracy and strength and reducing errors and latency.

Additionally, or alternatively, one or more operations of FIGS. 4-8 may be added, removed, substituted in other implementations. For example, in some implementations, the example steps of FIGS. 5 and 6 may be used together. To illustrate, the UE/downlink measurement operations of FIG. 5 may be used with the network/uplink measurement operations of FIG. 6. As another example, the example steps of FIGS. 7 and 8 may be used together. To illustrate, the UE/downlink measurement operations of FIG. 7 may be used with the network/uplink measurement operations of FIG. 8. In some such implementations, a round trip time (RTT) positioning determination may be used.

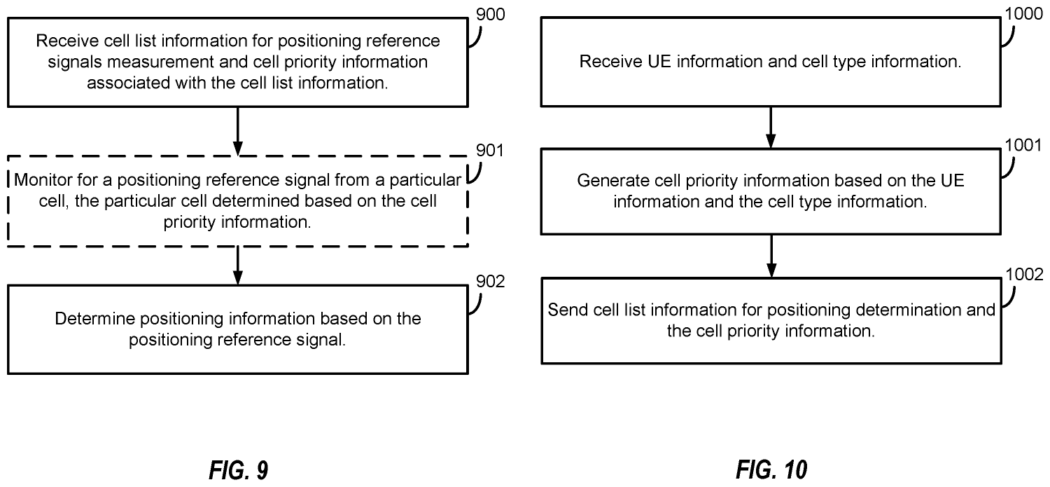

FIG. 9 is a flow diagram illustrating example blocks executed by a wireless communication device (e.g., UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1101a-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores positioning logic 1102, cell priority logic 1103, positioning report logic 1104, positioning measurement information 1105, cell priority information 1106, and settings data 1107.

Positioning logic 1102 may include or correspond to positioning manager 415, 439 and may be configured to perform the operations of the positioning manager 415, 439 as described in FIG. 4. For example, the positioning logic 1102 may determine resources for PRS/SRS transmission and/or feedback, PRS/SRS feedback settings, perform PRS/SRS measurement operations, or a combination thereof.

Cell priority logic 1103 may include or correspond to cell priority manager 416, 440 and may be configured to perform the operations of the cell priority manager 416, 440 as described in FIG. 4. For example, the cell priority logic 1103 may generate cell priority information 442 based on cell type and/or group information, and optionally based on UE information 406, such as UE type information, UE motion information, or both. As another example, the cell priority logic 1103 may utilize the cell priority information 442 to determine which reference signals/cells to measure and/or transmit reference signals to.

Positioning report logic 1104 may include or correspond to positioning manager 415, 439 and may be configured to perform the operations of the positioning manager 415, 439 as described in FIG. 4. For example, the positioning report logic 1104 may generate and transmit a positioning report which indicates the determined position (or measurements), and optionally which cells/base stations were used to determine the positioning (or measurements).

Positioning measurement information 1205 may include or correspond to positioning information 444. Cell priority information 1206 may include or correspond to cell priority information 442. Settings data 1207 may include or correspond to settings data 446.

At block 900, a wireless communication device, such as a UE or base station, obtains cell priority information for positioning reference signals measurement. For example, the UE 115 may receive the cell priority information 442 from the base station 105 or the network entity 405 (e.g., LMF). To illustrate, the UE 115 may receive the cell priority information 442 in the cell information transmission 454 as described in FIG. 4, or as described with reference to any of FIG. 5 or 6. In some such implementations, the device also receives cell list information for positioning reference signals measurement with the cell priority information, and the cell priority information is associated with the cell list information. As another example, the UE 115 may receive cell type or group information from a base station or LMF and may generate the cell priority information based on the received cell type or group information, as described with reference to FIGS. 7 and 8. As yet another example, the base station 105 may generate the cell priority information 442 (at least a portion thereof) and/or receive the cell priority information 442 from the LMF.

At block 901, the UE 115 monitors for a positioning reference signal from a particular cell, the particular cell determined based on the cell priority information. For example, the UE 115 monitors for and receives the reference signal transmission 456, which was selected based on the cell priority information 442, as described with reference to FIG. 4. To illustrate, the UE 115 may select the particular cell to receive the reference signal transmission 456 from based on the cell priority information, or the UE 115 may be instructed to use the particular cell, such as to monitor PRS transmissions therefrom. As another example, the UE 115 monitors for PRS transmissions at 535 and 540 of FIG. 5 or monitors for PRS transmissions at 725 and 730 of FIG. 7, as described with reference to FIGS. 5 and 7.

At block 902, the UE 115 determines positioning information based on the positioning reference signal. For example, the UE 115 determines the positioning information 444 based on the reference signal transmission 456, as described with reference to FIG. 4. As another example, the UE 115 determines the positioning information 444 based on the PRS transmissions at 535 and 540 of FIG. 5 or based on the PRS transmissions at 725 and 730 of FIG. 7, as described with reference to FIGS. 5 and 7.

The wireless communication device (e.g., UE or base station) may execute additional blocks (or the wireless communication device may be configured further perform additional operations) in other implementations. For example, the UE 115 may perform one or more operations described above.

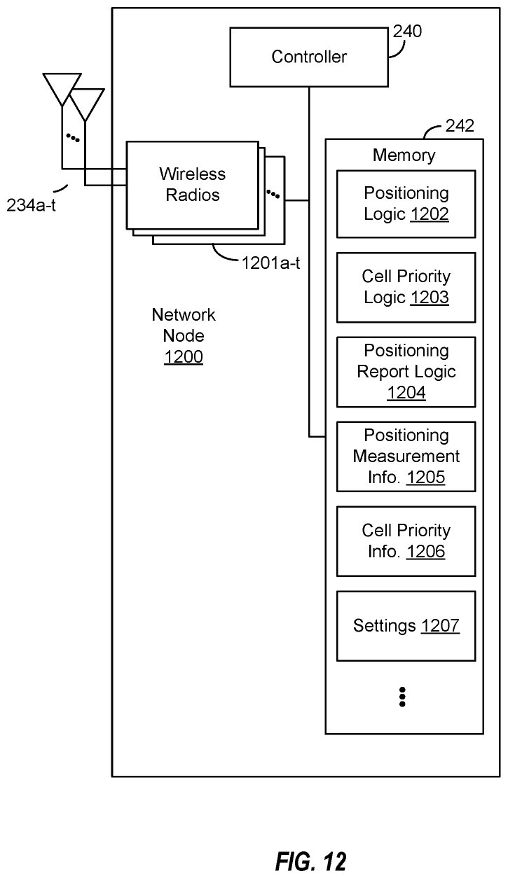

FIG. 10 is a flow diagram illustrating example blocks executed by a wireless communication device (e.g., UE or network entity, such as a base station or LMF) configured according to an aspect of the present disclosure. The example blocks will also be described with respect to network node 1200 as illustrated in FIG. 12. FIG. 12 is a block diagram illustrating network node 1200 configured according to one aspect of the present disclosure. Network node 1200 may include or correspond to one or more of a base station (e.g., the base station 105), a network entity (e.g., the network entity 405), or a LMF (e.g., the LMF 505), as described herein. Network node 1200 includes the structure, hardware, and components as illustrated for base station 105 of FIGS. 2 and/or 4. For example, network node 1200 includes controller/processor 280, which operates to execute logic or computer instructions stored in memory 282, as well as controlling the components of network node 1200 that provide the features and functionality of base station 105. Network node 1200, under control of controller/processor 280, transmits and receives signals via wireless radios 1201a-t and antennas 234a-t. Wireless radios 1201a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 12, memory 282 stores positioning logic 1202, cell priority logic 1203, positioning report logic 1204, positioning measurement information 1205, cell priority information 1206, and settings data 1207.

Positioning logic 1202 may include or correspond to positioning manager 415, 439 and may be configured to perform the operations of the positioning manager 415, 439 as described in FIG. 4. For example, the positioning logic 1202 may determine resources for PRS/SRS transmission and/or feedback, PRS/SRS feedback settings, perform PRS/SRS measurement operations, or a combination thereof.

Cell priority logic 1203 may include or correspond to cell priority manager 416, 440 and may be configured to perform the operations of the cell priority manager 416, 440 as described in FIG. 4. For example, the cell priority logic 1203 may generate cell priority information 442 based on cell type and/or group information, and optionally based on UE information 406, such as UE type information, UE motion information, or both. As another example, the cell priority logic 1203 may utilize the cell priority information 442 to determine which reference signals/cells to measure and/or transmit reference signals to.

Positioning report logic 1204 may include or correspond to positioning manager 415, 439 and may be configured to perform the operations of the positioning manager 415, 439 as described in FIG. 4. For example, the positioning report logic 1204 may generate and transmit a positioning report which indicates the determined position (or measurements), and optionally which cells/base stations were used to determine the positioning (or measurements).

Positioning measurement information 1205 may include or correspond to positioning information 444. Cell priority information 1206 may include or correspond to cell priority information 442. Settings data 1207 may include or correspond to settings data 446.

At block 1000, a wireless communication device, such as a base station 105, LMF 705-905, or a UE 115, receives user equipment (UE) information and cell type information. For example, the base station 105 or the network entity 405 receives UE information and cell type information. To illustrate, the base station 105 receives UE information from one or more UEs, such as UE 115, and optionally from the network entity 405, such as an LMF, as described with reference to FIGS. 4-6. As another illustration, the network entity 405 or the LMF 505, 605, receives cell type information from multiple base stations, such as base station 105, and UE information from multiple UEs, such as UE 115.

At block 1001, the wireless communication device generates cell priority information based on the UE information and the cell type information. For example, the base station 105 or the network entity 405 generates cell priority information 442 based on the UE information and the cell type information. To illustrate, the base station 105 or the network entity 405 generates the cell priority information 442 based on the UE information and the cell type information, as described with reference to FIG. 4, or the base station 105 or the LMF 505, 605 generates the cell priority information 442 based on the UE information and the cell type information, as described with reference to FIG. 5 or 6.

At block 1002, the wireless communication device sends the cell priority information. For example, the base station 105 or the network entity 405 transmits the cell priority information 442 to the UE 115 indicating cell priorities for SRS or PRS transmissions that are associated with certain UE types and/or operating conditions. To illustrate, the base station 105 or the network entity 405 transmits the cell priority information 442 to the UE 115 in the cell information transmission 454, as described with reference to FIG. 4, or as described with reference to FIG. 5 or 6. In some such implementations, the base station or LMF also sends cell list information 408 for positioning determination, as described with reference to any of FIGS. 4-8. The cell list information 408 may be sent with or separately from the cell priority information.

The network entity (e.g., base station 105 or LMF 705-905) may execute additional blocks (or the network entity may be configured further perform additional operations) in other implementations. For example, the base station 105 may perform one or more operations described above.

In a first aspect, a device for wireless communication includes at least one processor and a memory coupled to the at least one processor. The at least one processor is configured to cause the device to: obtain cell priority information for positioning reference signals measurement; monitor for a positioning reference signal from a particular cell, the particular cell determined based on the cell priority information; and determine positioning information based on the positioning reference signal.

In a second aspect, alone or in combination with one or more of the above aspects, the cell priority information indicates a category of a cell, and wherein the category of the cell includes a macro cell, a pico cell, a femto cell, a high speed train (HST) cell, a non-terrestrial network (NTN) cell, a high antenna cell, a wall-mounted cell, a roof-mounted cell, an unmanned aerial vehicle (UAV)-mounted cell, or an in-building cell.

In a third aspect, alone or in combination with one or more of the above aspects, the cell priority information indicates a group or rank of a cell, and wherein the group or rank of cell includes a priority level, a high priority group, a low priority group, a mobility priority group, or a stationary group.

In a fourth aspect, alone or in combination with one or more of the above aspects, the at least one processor is further configured to cause the device to: obtain cell list information for positioning reference signals measurement, wherein the cell priority information is associated with the cell list information; determine a list of cells from the cell list information; and select the particular cell from the list of cells based on the cell priority information.

In a fifth aspect, alone or in combination with one or more of the above aspects, the at least one processor configured to cause the device to select the particular cell from the list of cells based on the cell priority information includes to: determine a type of cell based on the cell priority information; and select the particular cell from the list of cells based on the type of cell.

In a sixth aspect, alone or in combination with one or more of the above aspects, the at least one processor configured to cause the device to select the particular cell from the list of cells based on the cell priority information includes to: determine a ranking of cells based on the cell priority information; and select the particular cell from the list of cells based on the ranking of cells.

In a seventh aspect, alone or in combination with one or more of the above aspects, the at least one processor is further configured to cause the device to: receive the positioning reference signal from a base station for the particular cell; measure the positioning reference signal from the base station to generate measurement information; and determine the positioning information based on the measurement information for the positioning reference signal.

In an eighth aspect, alone or in combination with one or more of the above aspects, the at least one processor is further configured to cause the device to: receive cell type information from at least one base station; and generate the cell priority information based on received cell type information and user equipment (UE) information.

In a ninth aspect, alone or in combination with one or more of the above aspects, the at least one processor is further configured to cause the device to: provide user equipment (UE) information to a location server, wherein the cell priority information is received responsive to providing the UE information. In some such aspects, alone or in combination with one or more of the above aspects, the location server correspond to a location management function (LMF).

In a tenth aspect, alone or in combination with one or more of the above aspects, the UE information includes UE type information, UE motion information, or both.

In an eleventh aspect, alone or in combination with one or more of the above aspects, the UE type information indicates a category of a UE, wherein the category of the UE includes an unmanned aerial vehicle (UAV) UE, a vehicle UE, an Internet-of-Things (IoT) UE, or a handheld UE.

In a twelfth aspect, alone or in combination with one or more of the above aspects, the UE motion information indicates a state of motion of the UE, and wherein the state of motion of the UE includes walking, running, cycling, on a vehicle, on a train, or flying.

In a thirteenth aspect, alone or in combination with one or more of the above aspects, the at least one processor configured to cause the device to provide the UE information to the location server includes to: transmit the UE type information and the UE motion information to a base station in positioning protocol transmission and indicating the location server.

In a fourteenth aspect, alone or in combination with one or more of the above aspects, the at least one processor is further configured to cause the device to: transmit the positioning information to a location server, the positioning information indicating a position of the device; and receive a transmission responsive to the positioning information and based on the position of the device indicated by the positioning information.

In a fifteenth aspect, alone or in combination with one or more of the above aspects, the at least one processor is further configured to cause the device to: transmit a transmission to a location server based on a position of the device indicated by the positioning information.

In a sixteenth aspect, alone or in combination with one or more of the above aspects, a device for wireless communication includes at least one processor and a memory coupled to the at least one processor. The at least one processor is configured to cause the device to: provide user equipment (UE) type information, UE motion information, or both to a location server; receive scheduling information for a sounding reference signal responsive to providing the UE type information, the UE motion information, or both; and transmit the sounding reference signal to one or more cells (e.g., enhanced or HST cells) based on the scheduling information, wherein the one or more cells are selected based on the UE type information, the UE motion information, or both as well as cell priority information.

In a seventeenth aspect, alone or in combination with one or more of the above aspects, the UE type information indicates a category of a UE, and wherein the category of the UE includes an unmanned aerial vehicle (UAV) UE, a vehicle UE, an Internet-of-Things (IoT) UE, or a handheld UE.

In an eighteenth aspect, alone or in combination with one or more of the above aspects, the UE motion information indicates a state of motion of the UE, and wherein the state of motion of the UE includes walking, running, cycling, on a vehicle, on a train, or flying.

In a nineteenth aspect, alone or in combination with one or more of the above aspects, the at least one processor configured to cause the device to provide the UE type information, the UE motion information, or both to the location server includes to: transmit the UE type information and the UE motion information to a base station in positioning protocol transmission and indicating the location server.

In a twentieth aspect, alone or in combination with one or more of the above aspects, a device for wireless communication includes at least one processor, and a memory coupled to the at least one processor. The at least one processor is configured to cause the device to: receive user equipment (UE) information and cell type information; generate cell priority information based on the UE information and the cell type information; and send the cell priority information.

In a twenty-first aspect, alone or in combination with one or more of the above aspects, the cell type information indicates a category of a cell, wherein the category of the cell includes a macro cell, a pico cell, a femto cell, a high speed train (HST) cell, a non-terrestrial network (NTN) cell, a high antenna cell, a wall-mounted cell, a roof-mounted cell, an unmanned aerial vehicle (UAV)-mounted cell, or an in-building cell.

In a twenty-second aspect, alone or in combination with one or more of the above aspects, the at least one processor configured to cause the device to: send cell list information for positioning determination, and the cell priority information includes a cell priority indication for multiple cells of the cell list information for one or more of uplink position determination operation, downlink position determination operation, or uplink and downlink position determination operations.

In a twenty-third aspect, alone or in combination with one or more of the above aspects, the UE information includes UE type information, UE motion information, or both for a particular UE.

In a twenty-fourth aspect, alone or in combination with one or more of the above aspects, the at least one processor configured to cause the device to generate the cell priority information based on the UE information and the cell type information includes to: generate the cell priority information for the particular UE based on the cell type information and based on the UE type information, the UE motion information, or both.

In a twenty-fifth aspect, alone or in combination with one or more of the above aspects, the at least one processor configured to cause the device to generate the cell priority information based on the cell type information and based on the UE type information, the UE motion information, or both includes to: generate the cell priority information based on the cell type information and the UE type information.

In a twenty-sixth aspect, alone or in combination with one or more of the above aspects, the at least one processor configured to cause the device to generate the cell priority information based on the cell type information and based on the UE type information, the UE motion information, or both includes to: generate the cell priority information based on the cell type information and the UE motion information.

In a twenty-seventh aspect, alone or in combination with one or more of the above aspects, the at least one processor configured to cause the device to generate the cell priority information based on the cell type information and based on the UE type information, the UE motion information, or both includes to: generate the cell priority information based on the cell type information, the UE type information, and the UE motion information.

In a twenty-eighth aspect, alone or in combination with one or more of the above aspects, the at least one processor configured to cause the device to receive the UE information includes to: receive the UE information from a UE in a positioning protocol transmission and via a base station.

In a twenty-ninth aspect, alone or in combination with one or more of the above aspects, the at least one processor configured to cause the device to receive the cell type information includes to: receive first cell type information from a first base station; and receive second cell type information from a second base station.

In a thirtieth aspect, alone or in combination with one or more of the above aspects, the at least one processor configured to cause the device to send the cell priority information includes to: transmit the cell priority information to a base station and indicating a particular UE as a recipient.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-13 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
obtain cell priority information for positioning reference signals measurement;
monitor for a positioning reference signal from a particular cell, the particular cell determined based on the cell priority information; and
determine positioning information based on the positioning reference signal.

2. The device of claim 1, wherein the cell priority information indicates a category of a cell, and wherein the category of the cell includes a macro cell, a pico cell, a femto cell, a high speed train (HST) cell, a non-terrestrial network (NTN) cell, a high antenna cell, a wall-mounted cell, a roof-mounted cell, an unmanned aerial vehicle (UAV)-mounted cell, or an in-building cell.

3. The device of claim 1, wherein the cell priority information indicates a group or rank of a cell, and wherein the group or rank of cell includes a priority level, a high priority group, a low priority group, a mobility priority group, or a stationary group.

4. The device of claim 1, wherein the at least one processor is further configured to cause the device to:
obtain cell list information for positioning reference signals measurement, wherein the cell priority information is associated with the cell list information;
determine a list of cells from the cell list information; and
select the particular cell from the list of cells based on the cell priority information.

5. The device of claim 4, wherein the at least one processor configured to cause the device to select the particular cell from the list of cells based on the cell priority information includes to:
determine a type of cell based on the cell priority information; and
select the particular cell from the list of cells based on the type of cell.

6. The device of claim 4, wherein the at least one processor configured to cause the device to select the particular cell from the list of cells based on the cell priority information includes to:
determine a ranking of cells based on the cell priority information; and
select the particular cell from the list of cells based on the ranking of cells.

7. The device of claim 1, wherein the at least one processor is further configured to cause the device to:
receive the positioning reference signal from a base station for the particular cell;
measure the positioning reference signal from the base station to generate measurement information; and
determine the positioning information based on the measurement information for the positioning reference signal.

8. The device of claim 1, wherein the at least one processor is further configured to cause the device to:
receive cell type information from at least one base station; and
generate the cell priority information based on received cell type information and user equipment (UE) information.

9. The device of claim 1, wherein the at least one processor is further configured to cause the device to:
provide user equipment (UE) information to a location server, wherein the cell priority information is received responsive to providing the UE information.

10. The device of claim 9, wherein the UE information includes UE type information, UE motion information, or both.

11. The device of claim 10, wherein the UE type information indicates a category of a UE, wherein the category of the UE includes an unmanned aerial vehicle (UAV) UE, a vehicle UE, an Internet-of-Things (IoT) UE, or a handheld UE.

12. The device of claim 10, wherein the UE motion information indicates a state of motion of the UE, and wherein the state of motion of the UE includes walking, running, cycling, on a vehicle, on a train, or flying.

13. The device of claim 10, wherein the at least one processor configured to cause the device to provide the UE information to the location server includes to:
transmit the UE type information and the UE motion information to a base station in positioning protocol transmission and indicating the location server.

14. The device of claim 1, wherein the at least one processor is configured to cause the device to:
transmit the positioning information to a location server, the positioning information indicating a position of the device; and
receive a transmission responsive to the positioning information and based on the position of the device indicated by the positioning information.

15. The device of claim 1, wherein the at least one processor is further configured to cause the device to:
transmit a transmission to a location server based on a position of the device indicated by the positioning information.

16. A device for wireless communication, comprising:
at least one processor; and
a memory coupled to the at least one processor,
wherein the at least one processor is configured to cause the device to:
provide user equipment (UE) type information, UE motion information, or both to a location server;
receive scheduling information for a sounding reference signal responsive to providing the UE type information, the UE motion information, or both; and
transmit the sounding reference signal to one or more cells based on the scheduling information, wherein the one or more cells are selected based on the UE type information, the UE motion information, or both, as well as cell priority information.

17. The device of claim 16, wherein the UE type information indicates a category of a UE, and wherein the category of the UE includes an unmanned aerial vehicle (UAV) UE, a vehicle UE, an Internet-of-Things (IoT) UE, or a handheld UE.

18. The device of claim 16, wherein the UE motion information indicates a state of motion of the UE, and wherein the state of motion of the UE includes walking, running, cycling, on a vehicle, on a train, or flying.

19. The device of claim 16, wherein the at least one processor configured to provide the UE type information, the UE motion information, or both to the location server includes to:
transmit the UE type information and the UE motion information to a base station in positioning protocol transmission and indicating the location server.

20. A device for wireless communication, comprising:
at least one processor; and
a memory coupled to the at least one processor,
wherein the at least one processor is configured to cause the device to:
receive user equipment (UE) information and cell type information;
generate cell priority information based on the UE information and the cell type information; and
send the cell priority information.

21. The device of claim 20, wherein the cell type information indicates a category of a cell, wherein the category of the cell includes a macro cell, a pico cell, a femto cell, a high speed train (HST) cell, a non-terrestrial network (NTN) cell, a high antenna cell, a wall-mounted cell, a roof-mounted cell, an unmanned aerial vehicle (UAV)-mounted cell, or an in-building cell.

22. The device of claim 20, wherein the at least one processor configured to cause the device to:
send cell list information for positioning determination, and wherein the cell priority information includes a cell priority indication for multiple cells of the cell list information for one or more of uplink position determination operation, downlink position determination operation, or uplink and downlink position determination operations.

23. The device of claim 20, wherein the UE information includes UE type information, UE motion information, or both for a particular UE.

24. The device of claim 23, wherein the at least one processor configured to cause the device to generate the cell priority information based on the UE information and the cell type information includes to:
generate the cell priority information for the particular UE based on the cell type information and based on the UE type information, the UE motion information, or both.

25. The device of claim 24, wherein the at least one processor configured to cause the device to generate the cell priority information based on the cell type information and based on the UE type information, the UE motion information, or both includes to:
generate the cell priority information based on the cell type information and the UE type information.

26. The device of claim 24, wherein the at least one processor configured to cause the device to generate the cell priority information based on the cell type information and based on the UE type information, the UE motion information, or both includes to:
generate the cell priority information based on the cell type information and the UE motion information.

27. The device of claim 24, wherein the at least one processor configured to cause the device to generate the cell priority information based on the cell type information and based on the UE type information, the UE motion information, or both includes to:
generate the cell priority information based on the cell type information, the UE type information, and the UE motion information.

28. The device of claim 20, wherein the at least one processor is further configured to receive the UE information includes to:
receive the UE information from a UE in a positioning protocol transmission and via a base station.

29. The device of claim 20, wherein the at least one processor configured to cause the device to receive the cell type information includes to:
receive first cell type information from a first base station; and
receive second cell type information from a second base station.

30. The device of claim 20, wherein the at least one processor configured to cause the device to send the cell priority information includes to:
transmit the cell priority information to a base station and indicating a particular UE as a recipient.
